(19) United States
(12) Patent Application Publication
(10) Pub. No.: US 2026/0160088 A1
(43) Pub. Date: Jun. 11, 2026

(54) MONITORING A SWIMMING POOL'S WATER CONDITION AND ACTIVITY BASED ON COMPUTER VISION, AND USING THIS MONITORING TO FACILITATE POOL MAINTENANCE

(71) Applicant: CORAL SMART POOL LTD, Binyamina (IL)

(72) Inventors: Tamar AVRAHAM, Haifa (IL); Bisharat SHADIE, Herzliya (IL); Lior LANGLEV, Ahuzat Barak (IL)

(73) Assignee: CORAL SMART POOL LTD, Binyamina (IL)

(21) Appl. No.: 19/123,120

(22) PCT Filed: Oct. 24, 2023
(86) PCT No.: PCT/IL2023/051097

§ 371 Date: Apr. 22, 2025

Related U.S. Application Data
(60) Provisional application No. 63/380,681, filed on Oct. 24, 2022.

(51) Int. Cl. E04H 4/16; C02F 1/00; C02F 1/40; C02F 1/50; C02F 1/68; C02F 103/42; G06V 10/26; G06V 10/774; G06V 20/05; G06V 20/20; G06V 20/52; H04N 7/18

(52) U.S. Cl. CPC E04H 4/1654; C02F 1/001; C02F 1/008; C02F 1/40; C02F 1/50; C02F 1/685; G06V 10/774; G06V 20/05; G06V 20/20; G06V 20/52; H04N 7/185; C02F 2103/42; C02F 2209/11; C02F 2209/42; C02F 2303/04; G06V 10/26

(57) ABSTRACT

Systems and methods comprising obtaining underwater images of a swimming pool acquired by at least one underwater camera, and feeding the underwater images, or data informative thereof, to at least one machine learning model to determine at least one of data D_{water_condition} informative of water condition in the swimming pool, or data D_{activity} informative of an activity within the swimming pool, wherein at least one of the data D_{water_condition} or D_{activity} is usable to perform an action associated with maintenance of the swimming pool are included. Various additional systems and method in the field of swimming pool's maintenance are provided.

### TECHNICAL FIELD

The presently disclosed subject matter relates to the field of swimming pools, and, in particular, the maintenance of swimming pools.

### BACKGROUND

A swimming pool requires maintenance, which includes e.g., cleaning of the swimming pool.

References considered to be relevant as background to the presently disclosed subject matter are listed below (acknowledgement of the references herein is not to be inferred as meaning that these are in any way relevant to the patentability of the presently disclosed subject matter):
U.S. Pat. No. 9,388,595;
US 2022/0129005;
U.S. Pat. No. 11,306,500;
U.S. Pat. No. 10,961,738;
U.S. Pat. No. 9,506,262;
U.S. Pat. No. 10,107,000;
U.S. Pat. No. 11,339,580;
U.S. Pat. No. 10,209,719;
US 2007/0067930;
U.S. Pat. No. 9,903,131;
US 2021/0388628;
US 2020/0246690;
US 2021/0096517;
U.S. Pat. No. 11,076,734;
CN 114581720;
U.S. Pat. No. 10,364,585;
U.S. Pat. No. 11,108,585.

There is now a need to propose new solutions for improving automatic monitoring of swimming pools, and for improving maintenance of swimming pools.

### GENERAL DESCRIPTION

In accordance with certain aspects of the presently disclosed subject matter, there is provided a method comprising, by at least one processing circuitry, obtaining underwater images of a swimming pool acquired by at least one underwater camera, feeding the underwater images to the at least one machine learning model to determine at least one of data D_{water_condition} informative of water condition in the swimming pool, or data D_{activity} informative of an activity within the swimming pool, wherein at least one of data D_{water_condition} oor D_{activity} is usable to perform an action associated with maintenance the swimming pool.

In addition to the above features, the method according to this aspect of the presently disclosed subject matter can optionally comprise one or more of features (i) (xvi) and/or (xvii) to (xxvii) and/or (xxviii) to (xli) and/or (xlii) to (xlvii) and/or (xlvii) to (lix) in any technically possible combination or permutation:
i. the method uses at least one of the data D_{water_condition} or D_{activity} to perform an action associated with maintenance of the swimming pool;
ii. the action comprises displaying at least one of data D_{water_condition} or D_{activity} on a display device to a user, thereby facilitating maintenance of the swimming pool for the user;
iii. the swimming pool is associated with a pool cleaning machinery for cleaning the swimming pool, wherein the action includes controlling the pool cleaning machinery based on at least one of data D_{water_condition} or D_{activity},
iv. controlling the pool cleaning machinery includes controlling at least one of a filter of the swimming pool, or a pump of the swimming pool, or a device enabling delivering chemicals in the swimming pool;
v. the data D_{water_condition} includes data D_{dirt} informative of underwater dirt elements present in the swimming pool;
vi. the data D_{dirt} informative of dirt elements present in the swimming pool includes at least one of: location of the dirt elements, or amount of the dirt elements per location, or type of the dirt elements;
vii. the method comprises obtaining one or more above-water images of the swimming pool acquired by at least one above-water camera and feeding the one or more above-water images to a machine learning model to determine data informative of floating dirt elements present in the swimming pool;
viii. the method comprises obtaining an above-water image of the swimming pool acquired by at least one above-water camera, wherein the above-water image includes a skimmer of the swimming pool, feeding the above-water image to a machine learning model to determine data informative of dirt elements obstructing the skimmer, and performing an action when an amount of dirt elements obstructing the skimmer is above a threshold;
ix. the method comprises obtaining at least one above-water image of a swimming pool acquired by at least one above-water camera, and feeding the above-water image to a machine learning model to determine data informative of water level of the swimming pool;
x. the method comprises feeding the above-water image to the machine learning model to detect that the water level of the pool is below a threshold, and upon said detection, sending a command to a device to fill the swimming pool with water, or feeding the above-water image to the machine learning model to detect that the water level of the pool is above a threshold, and upon said detection, sending a command to a device to remove water from the swimming pool;
xi. the above-water image includes an image of a skimmer of the swimming pool;
xii. data D_{activity} includes data informative of human activity in the swimming pool, wherein the system is configured to use said data informative of human activity in the swimming pool to perform the action associated with maintenance of the pool;
xiii. the action includes at least one of sending a recommendation to a user to trigger cleaning of the pool or sending a command to a pool cleaning machinery to clean the pool;
xiv. the data D_{activity} includes data informative of human activity in the swimming pool, and wherein the data D_{water_condition} includes data D_{dirt} informative of dirt elements present in the swimming pool, wherein the method comprises using both said data informative of human activity in the swimming pool and said data D_{dirt} to perform the action associated with maintenance of the swimming pool;
xv. the action includes at least one of sending a recommendation to a user to trigger cleaning of the pool or sending a command to a pool cleaning machinery to clean the pool;
xvi. the machine learning model has been trained using a training set of underwater images of a swimming pool, wherein each underwater image of the training set of is associated with a label indicative of at least one of data D_{water_condition} informative of water condition in the swimming pool, or data D_{activity} informative of an activity within the swimming pool.

According to some embodiments, a system comprising at least one processing circuitry configured to perform this method (optionally including one or more of features (i) to (xvi) and/or (xvii) to (xxvii) and/or (xxviii) to (xli) and/or (xlii) to (xlvii) and/or (xlvii) to (lix)) and a non-transitory computer readable medium comprising instructions that, when executed by at least one processing circuitry, cause the at least one processing circuitry to perform operations of this method (optionally including one or more of features (i) to (xvi) and/or (xvii) to (xxvii) and/or (xxviii) to (xli) and/or (xlii) to (xlvii) and/or (xlvii) to (lix)), are provided.

In accordance with certain aspects of the presently disclosed subject matter, there is provided a method comprising, by at least one processing circuitry, obtaining one or more underwater images of a swimming pool acquired by at least one underwater camera, and feeding the one or more underwater images to a machine learning model to determine data D_{dirt} informative of dirt elements present in the swimming pool.

In addition to the above features, the method according to this aspect of the presently disclosed subject matter can optionally include one or more of features (i) to (xvi) and/or (xvii) to (xxvii) and/or (xxviii) to (xli) and/or (xlii) to (xlvii) and/or (xlvii) to (lix), in any technically possible combination or permutation:
xvii. the method comprises using the data D_{dirt} to perform an action associated with maintenance of the swimming pool;
xviii. the machine learning model is trained to differentiate, in a given underwater image of a swimming pool, between dirt elements present in the given underwater image and non-dirt elements present in the given underwater image;
xix. the non-dirt elements include at least one of pool features or a shade of one or more elements;
xx. the method comprises obtaining a feedback of a user on a location of one or more specific non-dirt elements in one or more of the underwater images and using the feedback to train the machine learning model to classify said one or more specific non-dirt elements as non-dirt elements;
xxi. the data D_{dirt} includes a location of the dirt elements;
xxii. the machine learning model is operative to identify dirt elements in underwater images of a swimming pool, and for each dirt element, determine a given segment of the swimming pool in which the dirt element is located, wherein the given segment is selected among a plurality of predefined segments mapping a geometry of the swimming pool;
xxiii. the plurality of predefined segments includes at least one of a floor of the pool, a right wall of the pool, a left wall of the pool, a rear wall of the pool, a front wall of the pool, a wall of the pool, and steps of the pool;
xxiv. the processing circuitry is operative to implement a first machine learning model and a second machine learning model, wherein the method comprises feeding at least one underwater image of the pool to the first machine learning model to map a geometry of the pool in the image into a plurality of segments, determining, using the second machine learning model and the plurality of segments determined by the first machine learning model, a location of dirt elements expressed with reference to one or more of the plurality of segments;

xxv. the method comprises using the data D_{dirt} informative of dirt elements present in the swimming pool to control a path of a mobile cleaning device operative to clean the swimming pool;
xxvi. the method comprises obtaining one or more above-water images of the swimming pool acquired by at least one above-water camera, and feeding the one or more above-water images to a machine learning model to determine data informative of floating dirt elements present in the swimming pool;
xxvii. the machine learning model has been trained using a training set of underwater images of a swimming pool, wherein each underwater image of the training set is associated with a label indicative of data D_{dirt}informative of dirt elements present in the swimming pool.

According to some embodiments, a system comprising at least one processing circuitry configured to perform this method (optionally including one or more of features (i) to (xvi) and/or (xvii) to (xxvii) and/or (xxviii) to (xli) and/or (xlii) to (xlvii) and/or (xlvii) to (lix), and a non-transitory computer readable medium comprising instructions that, when executed by at least one processing circuitry, cause the at least one processing circuitry to perform operations of this method (optionally including one or more of features (i) to (xvi) and/or (xvii) to (xxvii) and/or (xxviii) to (xli) and/or (xlii) to (xlvii) and/or (xlvii) to (lix)), are provided.

In accordance with certain aspects of the presently disclosed subject matter, there is provided a method comprising, by at least one processing circuitry, obtaining at least one underwater image of a swimming pool acquired by at least one underwater camera, and feeding the underwater image to the machine learning model to map a geometry of the swimming pool present in the underwater image into a plurality of segments.

According to some embodiments, the segments include at least one of: floor of the pool, wall of the pool, left wall of the pool, right wall of the pool, front wall of the pool, rear wall of the pool, a wall of the pool, and steps of the pool.

According to some embodiments, the method comprises using the segments to determine at least one of: location or amount of dirt elements present in the swimming pool, human activity in the swimming pool, turbidity in the swimming pool.

According to some embodiments, the machine learning model has been trained using a training set of underwater images of a swimming pool, wherein each underwater image of the training set is associated with a label indicative of segments of the swimming pool.

In accordance with certain aspects of the presently disclosed subject matter, there is provided a method comprising, by at least one processing circuitry, obtaining one or more underwater images of a swimming pool acquired by at least one underwater camera, and feeding the one or more underwater images to a machine learning model to determine data D_{turbidity} informative of water turbidity in the swimming pool.

According to some embodiments, the the machine learning model has been trained using a training set of underwater images of a swimming pool, wherein each underwater image of the training set is associated with a label indicative of data D_{turbidity} informative of water turbidity in the swimming pool.

In addition to the above features, the method according to this aspect of the presently disclosed subject matter can optionally comprise one or more of features (i) to (xvi) and/or (xvii) to (xxvii) and/or (xxviii) to (xli) and/or (xlii) to (xlvii) and/or (xlvii) to (lix), in any technically possible combination or permutation:
xxviii. said determination of data D_{turbidity} comprises, at least one of: (i) determining, by the machine learning model, the data D_{turbidity} informative of water turbidity in the swimming pool, or (ii) using an output of the machine learning model to determine the data D_{turbidity} informative of water turbidity in the swimming pool;
xxix. the method comprises using data D_{turbidity} to perform an action associated with maintenance of the swimming pool;
xxx. the pool is associated with a pool cleaning machinery operative to perform cleaning operations of the pool, wherein the system is configured to use data D_{turbidity} to detect that water turbidity exceeds a threshold, and to control the pool cleaning machinery to reduce water turbidity;
xxxi. the method comprises feeding the one or more underwater images to the machine learning model to determine data informative of one or more reasons for water turbidity in the swimming pool;
xxxii. the pool is associated with a pool cleaning machinery including a plurality of cleaning devices, wherein the method comprises sending a command to a given cleaning device selected among the plurality of cleaning devices, for cleaning the pool, wherein the given cleaning device is selected based on the data informative of one or more reasons for water turbidity in the swimming pool;
xxxiii. the reasons for water turbidity may include at least one of: one or more improper levels of chlorine, imbalanced pH and alkalinity, high calcium hardness (CH) levels, faulty or clogged filter, early stages of algae, ammonia, or debris;
xxxiv. the machine learning model has been trained using a training set of underwater images of a swimming pool, wherein each underwater image of the training set is associated with a label indicative of data D_{turbidity} informative of water turbidity in the swimming pool;
xxxv. wherein the label includes, for each given underwater images of a plurality of underwater images of the training set of underwater images, at least one of (i) level of turbidity in said given underwater image, (ii) one or more turbidity values in said given underwater image, expressed Formazin Nephelometric Units (FNU) or in Nephelometric Turbidity Units (NTU), or (iii) position of one or more areas in said given underwater images, in which turbidity meets a criterion;
xxxvi. data D_{turbidity} includes one or more values of turbidity expressed in Formazin Nephelometric Units (FNU) or in Nephelometric Turbidity Units (NTU);
xxxvii. the method comprises raising an alarm when the one or more values of turbidity expressed in Formazin Nephelometric Units (FNU) or in Nephelometric Turbidity Units (NTU) are above a threshold;
xxxviii. the machine learning model is operative to determine one or more areas of the one or more underwater images in which turbidity meeting a criterion is present, wherein the method comprises using the one or more areas to determine data D_{turbidity},
xxxix. the method comprises using one or more dimensions of the one or more areas to determine data D_{turbidity},
xl. the machine learning model is configured to determine one or more areas of the one or more underwater images in which turbidity meeting a criterion is present, wherein the method comprises using the one or more areas to determine one or more values of turbidity expressed in Formazin Nephelometric Units (FNU) or in Nephelometric Turbidity Units (NTU);
xli. the machine learning model is configured to determine D_{turbidity}, wherein D_{turbidity} comprises one or more values of turbidity expressed in Formazin Nephelometric Units (FNU) or in Nephelometric Turbidity Units (NTU).

According to some embodiments, a system comprising at least one processing circuitry configured to perform this method (optionally including one or more of features to (xvi) and/or (xvii) to (xxvii) and/or (xxviii) to (xli) and/or (xlii) to (xlvii) and/or (xlvii) to (lix)), and a non-transitory computer readable medium comprising instructions that, when executed by at least one processing circuitry, cause the at least one processing circuitry to perform operations of this method (optionally including one or more of features (i) to (xvi) and/or (xvii) to (xxvii) and/or (xxviii) to (xli) and/or (xlii) to (xlvii) and/or (xlvii) to (lix)), are provided.

In accordance with certain aspects of the presently disclosed subject matter, there is provided a method comprising, by at least one processing circuitry, wherein the at least one processing circuitry is operative to implement at least one machine learning model, obtaining at least one above-water image of a swimming pool acquired by at least one above-water camera, and feeding the above-water image to a machine learning model to determine data informative of water level of the swimming pool.

According to some embodiments, the above-water image includes a skimmer of the swimming pool.

According to some embodiments, the method comprises feeding the above-water image to the machine learning model to detect that the water level of the swimming pool is below a threshold, and upon said detection, sending a command to a device to fill the swimming pool with water.

According to some embodiments, the swimming pool is associated with a skimmer, wherein the method comprises using the machine learning model to detect a skimmer in the above-water image, determining a location at which the water level crosses the skimmer, and using said location to determine whether the water level meets a required threshold.

According to some embodiments, the machine learning model has been trained using a training set of underwater images of a swimming pool, wherein each underwater image of the training set is associated with a label indicative of data informative of water level of the swimming pool.

In accordance with certain aspects of the presently disclosed subject matter, there is provided a method comprising, by at least one processing circuitry operative to implement at least one machine learning model, obtaining underwater images of a swimming pool acquired by at least one underwater camera, using a machine learning model to detect, in the underwater images, a mobile cleaning device operative to clean the swimming pool, and using said detection to determine data informative of a path of the mobile cleaning device in the swimming pool.

In addition to the above features, the method according to this aspect of the presently disclosed subject matter can optionally comprise one or more of (i) to (xvi) and/or (xvii) to (xxvii) and/or (xxviii) to (xli) and/or (xlii) to (xlvii) and/or (xlvii) to (lix), in any technically possible combination or permutation:
xlii. the data informative of a path of the mobile cleaning device in the pool includes a map informative of a coverage of the swimming pool by the mobile cleaning device;
xliii. the data informative of a position of the mobile cleaning device in the pool is informative, for each position, of time spent by the mobile cleaning device at said position;
xliv. the data informative of a position of the mobile cleaning device in the swimming pool includes a heat map informative, for each position, of the time spent by the mobile cleaning device at said position;
xlv. the method comprises using data informative of a path of the mobile cleaning device in the swimming pool, to generate a report informative of a performance of the mobile cleaning device;
xlvi. the method comprises outputting at least one of a total duration during which the mobile cleaning robot has operated during a given cleaning operation of the swimming pool, statistics on duration required by the mobile cleaning robot for cleaning the swimming pool, an underwater image before pool cleaning and an underwater image after pool cleaning by the mobile cleaning device, a pointer on dirt elements before cleaning by the mobile cleaning device, and a pointer on dirt elements left after cleaning by the mobile cleaning device, data informative of the parts of the pool which have not been cleaned by the mobile cleaning device, data informative of the parts of the pool which have been cleaned by the mobile cleaning device with a duration below a threshold, data informative of the parts of the pool which have been cleaned by the mobile cleaning device with a duration above a threshold;
xlvii. the machine learning model has been trained using a training set of underwater images of a swimming pool, wherein each underwater image of the training set is associated with a label indicative of a location of a mobile cleaning device.

According to some embodiments, a system comprising at least one processing circuitry configured to perform this method (optionally including one or more of the features (i) to (xvi) and/or (xvii) to (xxvii) and/or (xxviii) to (xli) and/or (xlii) to (xlvii) and/or (xlvii) to (lix)) and a non-transitory computer readable medium comprising instructions that, when executed by at least one processing circuitry, cause the at least one processing circuitry to perform operations of this method (optionally including one or more of the features (i) to (xvi) and/or (xvii) to (xxvii) and/or (xxviii) to (xli) and/or (xlii) to (xlvii) and/or (xlvii) to (lix)) are provided.

In accordance with certain aspects of the presently disclosed subject matter, there is provided a method comprising, by at least one processing circuitry operative to implement at least one machine learning model, obtaining at least one underwater image of a swimming pool acquired by at least one underwater camera, wherein the swimming pool is associated with at least one mobile cleaning device operative to clean the swimming pool, feeding the underwater image to the machine learning model to determine data D_{dirt} informative of dirt elements present in the swimming pool, and using the data D_{dirt} to control the mobile cleaning device, for cleaning at least part of the dirt elements present in the swimming pool.

In addition to the above features, the method according to this aspect of the presently disclosed subject matter can optionally comprise one or more of (i) to (xvi) and/or (xvii) to (xxvii) and/or (xxviii) to (xli) and/or (xlii) to (xlvii) and/or (xlvii) to (lix), in any technically possible combination or permutation:
xlviii. the method comprises using the data D_{dirt} informative of dirt elements present in the swimming pool to control a speed of the mobile cleaning device;
xlix. the method comprises triggering cleaning of the swimming pool by the mobile cleaning device using at least one of the data D_{dirt} informative of dirt elements present in the swimming pool, or data D_{turbidity} informative of water turbidity, or data informative of human activity in the swimming pool;
l. the method comprises controlling a path of the mobile cleaning device using data informative of an amount of dirt elements present in the swimming pool;
li. the method comprises controlling a path of the mobile cleaning device to optimize energy consumption by the mobile cleaning device according to an optimization criterion;
lii. the method comprises controlling the mobile cleaning device to enable cleaning of most or all of the swimming pool at least once, using energy provided only by a battery of the mobile cleaning device, and without requiring recharging said battery during said cleaning;
liii. the mobile cleaning device is associated with a plurality of different cleaning systems, wherein the method comprises sending a command to the mobile cleaning device to operate a given selected cleaning system from different cleaning systems of the mobile cleaning device;
liv. selection of the given selected cleaning system depends on the data D_{dirt};
lv. the method comprises detecting, using at least one underwater image, that dirt elements have been removed by the mobile cleaning device at a given location, and using said detection to modify a planned path of the mobile cleaning device;
lvi. the method comprises detecting, using at least one underwater image, that dirt elements are still present at a given location after a cleaning operation by the mobile cleaning device at this given location, and using said detection to modify a planned path of the mobile cleaning device;
lvii. the method comprises determining an actual path of the mobile cleaning device in underwater images of the swimming pool, comparing the actual path with a planned path of the mobile cleaning device, and, based on said comparison, send a command to the mobile cleaning device;
lviii. the method comprises determining at least one of: (a) data informative of a position of the mobile cleaning device in the pool, or (b) data informative, for each position of the mobile cleaning device, of a time spent by the mobile cleaning device at said position, and using at least one of the data determined at (a) or (b) to control the mobile cleaning device;
lix. the machine learning model has been trained using a training set of underwater images of a swimming pool, wherein each underwater image of the training set is associated with a label indicative of data D_{dirt} informative of dirt elements present in the swimming pool.

According to some embodiments, a system comprising at least one processing circuitry configured to perform this method (optionally including (i) to (xvi) and/or (xvii) to (xxvii) and/or (xxviii) to (xli) and/or (xlii) to (xlvii) and/or (xlvii) to (lix)) and a non-transitory computer readable medium comprising instructions that, when executed by at least one processing circuitry, cause the at least one processing circuitry to perform operations of this method (optionally including one or more of the features (i) to (xvi) and/or (xvii) to (xxvii) and/or (xxviii) to (xli) and/or (xlii) to (xlvii) and/or (xlvii) to (lix)) are provided.

In accordance with certain aspects of the presently disclosed subject matter, there is provided a method comprising, by at least one processing circuitry, obtaining a training set comprising a plurality of underwater images of a swimming pool, obtaining, for each underwater water of the training set, a label indicative of at least one of data D_{water_condition} informative of water condition in the swimming pool, or data D_{activity} informative of an activity within the swimming pool, and feed each underwater image of the training set with its label to the machine learning model for its training, wherein the machine learning is operative, after its training, to determine, in a given underwater image of a given swimming pool, at least one of data D_{water_condition} informative of water condition in the given swimming pool, or data D_{activity} informative of an activity within the given swimming pool.

According to some embodiments, a system comprising at least one processing circuitry configured to perform this method, and a non-transitory computer readable medium comprising instructions that, when executed by at least one processing circuitry, cause the at least one processing circuitry to perform operations of this method, are provided.

In accordance with certain aspects of the presently disclosed subject matter, there is provided a method comprising, by at least one processing circuitry, obtaining a training set comprising a plurality of underwater images of a swimming pool, obtaining, for each underwater water of the training set, a label indicative of data informative of dirt elements present in the swimming pool, and feed each underwater image of the training set with its label to the machine learning model for its training, wherein the machine learning is operative, after its training, to determine, in a given underwater image of a given swimming pool, data D_{dirt} informative of dirt elements present in the given swimming pool.

According to some embodiments, a system comprising at least one processing circuitry configured to perform this method, and a non-transitory computer readable medium comprising instructions that, when executed by at least one processing circuitry, cause the at least one processing circuitry to perform operations of this method, are provided.

In accordance with certain aspects of the presently disclosed subject matter, there is provided a method comprising, by at least one processing circuitry, obtaining a training set comprising a plurality of underwater images of a swimming pool, obtaining, for each underwater water of the training set, a label indicative of segments of the swimming pool, and feed each underwater image of the training set with its label to the machine learning model for its training, wherein the machine learning is operative, after its training, to map a geometry of a given swimming pool present in a given underwater image into a plurality of segments.

According to some embodiments, a system comprising at least one processing circuitry configured to perform this method, and a non-transitory computer readable medium comprising instructions that, when executed by at least one processing circuitry, cause the at least one processing circuitry to perform operations of this method, are provided.

In accordance with certain aspects of the presently disclosed subject matter, there is provided a method comprising, by at least one processing circuitry, obtaining a training set comprising a plurality of underwater images of a swimming pool, obtaining, for each underwater water of the training set, a label indicative of water turbidity in the swimming pool, and feed each underwater image of the training set with its label to the machine learning model for its training, wherein the machine learning is operative, after its training, to determine, in a given underwater image of a given swimming pool, determine data D_{turbidity} informative of water turbidity in the given swimming pool.

According to some embodiments, a system comprising at least one processing circuitry configured to perform this method, and a non-transitory computer readable medium comprising instructions that, when executed by at least one processing circuitry, cause the at least one processing circuitry to perform operations of this method, are provided.

In accordance with certain aspects of the presently disclosed subject matter, there is provided a method comprising, by at least one processing circuitry, obtaining a training set comprising a plurality of above-water images of a swimming pool, obtaining, for each above-water of the training set, a label indicative of water level in the swimming pool, and feed each underwater image of the training set with its label to the machine learning model for its training, wherein the machine learning is operative, after its training, to determine, in a given above-water image of a given swimming pool, determine data informative of water level in the given swimming pool.

According to some embodiments, a system comprising at least one processing circuitry configured to perform this method, and a non-transitory computer readable medium comprising instructions that, when executed by at least one processing circuitry, cause the at least one processing circuitry to perform operations of this method, are provided.

In accordance with certain aspects of the presently disclosed subject matter, there is provided a method comprising, by at least one processing circuitry, obtaining a training set comprising a plurality of underwater images of one or more swimming pools, obtaining, for each underwater image of the training set, a label indicative of a location of a mobile cleaning device in the underwater image, and feed each underwater image of the training set with its label to the machine learning model for its training, wherein the machine learning is operative, after its training, to determine, in a given underwater image of a given swimming pool, data informative of a location of a mobile cleaning device of the given swimming pool in the given underwater image.

According to some embodiments, a system comprising at least one processing circuitry, configured to perform this method, and a non-transitory computer readable medium comprising instructions that, when executed by at least one processing circuitry, cause the at least one processing circuitry to perform operations of this method, are provided.

According to some embodiments, the proposed solution proposes an efficient and accurate computerized solution to monitor a swimming pool, which can be used in particular to improve/optimize maintenance of the swimming pool.

According to some embodiments, the proposed solution provides accurate and enriched feedback informative of the swimming pool. In particular, the feedback can be informative of the water condition of the swimming pool, and/or of the activity (human and/or robot activity) in the swimming pool.

According to some embodiments, the proposed solution provides various analytics on the status of the swimming pool, based on underwater camera images, which are usable to improve/optimize pool maintenance.

According to some embodiments, the proposed solution enables monitoring of the activity of the cleaning robot of the swimming pool.

According to some embodiments, the proposed solution reduces the time required by the cleaning robot to clean the swimming pool. As a consequence, according to some embodiments, it enables the cleaning robot to operate on-battery while cleaning the swimming pool.

According to some embodiments, the proposed solution increases the coverage of the swimming pool by the cleaning robot, thereby improving cleaning of the swimming pool.

According to some embodiments, the proposed solution increases the coverage of the swimming pool by the cleaning robot (e.g., up to 100 percent) while reducing the time required by the cleaning robot to clean the swimming pool (20-30 minutes instead of 90 minutes—this is not limitative).

According to some embodiments, the proposed solution enables a dynamic control of the cleaning robot of the swimming pool.

According to some embodiments, the proposed solution provides a visual (heat map/coverage map) feedback on the performance of the cleaning robot.

According to some embodiments, the proposed solution optimizes energy consumption used for pool maintenance (with respect to prior art systems, in which energy consumption can be very large and unoptimized).

According to some embodiments, the proposed solution enables determining turbidity value(s) in a swimming pool, without requiring usage of prior-art costly sensors or systems.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1A illustrates an embodiment of a system which can be used to perform one or more of the methods described hereinafter;

FIG. 1B illustrates an embodiment of a pool unit (underwater unit) which can embed at least part of the system of FIG. 1A;

FIG. 1C illustrates an embodiment of a system for detecting human drowning, which can embed at least part of the system of FIG. 1A;

FIG. 2 illustrates an embodiment of a method of using underwater images to determine data usable for facilitating pool maintenance;

FIG. 3A illustrates an embodiment of a method of determining data informative of dirt elements in a swimming pool;

FIG. 3B illustrates an underwater image of a swimming pool, including dirt elements and pool features;

FIG. 3C illustrates an output of the method of FIG. 3A on the image of FIG. 3B;

FIG. 3D illustrates an embodiment of a method of mapping a geometry of the inner part of a pool;

FIG. 3E illustrates an example of an output of the method of FIG. 3D;

FIG. 4A illustrates an embodiment of a method of determining data informative of dirt elements in a swimming pool, which uses a mapping of the inner part of the pool into segments;

FIG. 4B illustrates a non-limitative architecture which can be used to perform the method of FIG. 4A;

FIG. 5A illustrates an embodiment of a method of using feedback of a user to train a machine learning model to differentiate between dirt elements and non-dirt elements;

FIG. 5B illustrates an example of the method of FIG. 5A;

FIG. 6A illustrates an embodiment of a method of determining water turbidity in a swimming pool;

FIG. 6B illustrates an example of underwater images which can be processed in the method of FIG. 6A;

FIG. 6C illustrates an embodiment of a method of determining reasons for water turbidity in a swimming pool;

FIG. 6D illustrates an embodiment of a method of using water turbidity to perform an action;

FIG. 6E illustrates an example of an output of the method of FIG. 6D;

FIG. 6F illustrates an embodiment of a method of using reasons for water turbidity to perform an action;

FIG. 7A illustrates an embodiment of a method of determining data informative of floating dirt elements in a swimming pool;

FIGS. 7B and 7C illustrates images which can be processed in the method of FIG. 7A;

FIG. 8A illustrates an embodiment of a method of determining data informative of water level in a swimming pool;

FIG. 8B illustrates images which can be processed in the method of FIG. 8A;

FIG. 9A illustrates an embodiment of a method of determining data informative of a path of a mobile cleaning device in a swimming pool;

FIG. 9B illustrates an example of detection of a mobile cleaning device;

FIG. 9C illustrates an example of an output of the method of FIG. 9A;

FIGS. 9D and 9E illustrate examples of heat maps for the mobile cleaning device;

FIG. 10 illustrates an embodiment of a method of determining data informative of human activity in a swimming pool;

FIG. 11 illustrates an embodiment of a method of controlling a mobile cleaning device;

FIG. 12 illustrates a control of a mobile cleaning device in accordance with the method of FIG. 11;

FIG. 13 illustrates various operations which can be performed to control a mobile cleaning device, and which enable optimizing energy consumption by the mobile cleaning device;

FIG. 14 illustrates an embodiment of a method of dynamically controlling a path of mobile cleaning device;

FIG. 15A illustrates another embodiment of a method of dynamically controlling a path of mobile cleaning device; and

FIG. 15B illustrates another embodiment of a method of dynamically controlling a path of mobile cleaning device.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods have not been described in detail so as not to obscure the presently disclosed subject matter.

Unless specifically stated otherwise, as apparent from the following discussions, it is appreciated that throughout the specification, discussions utilizing terms such as “obtaining”, “using”, “feeding”, “determining”, “estimating”, “training”, “transmitting”, “communicating”, “sending”, “identifying”, “controlling”, “raising”, or the like, refer to the action(s) and/or process(es) of a computer that manipulate and/or transform data into other data, said data represented as physical, such as electronic, quantities and/or said data representing the physical objects.

The terms “computer” or “computerized system” should be expansively construed to include any kind of hardware-based electronic device with a data processing circuitry (e.g., digital signal processor (DSP), a GPU, a TPU, a field programmable gate array (FPGA), an application specific integrated circuit (ASIC), microcontroller, microprocessor etc.). The processing circuitry can comprise, for example, one or more processors operatively connected to computer memory, loaded with executable instructions for executing operations, as further described below. The processing circuitry encompasses a single processor or multiple processors, which may be located in the same geographical zone, or may, at least partially, be located in different zones, and may be able to communicate together.

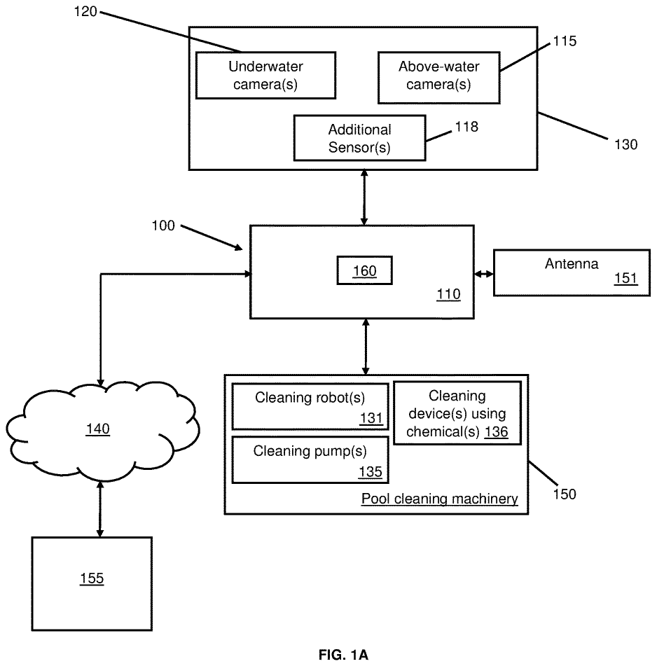

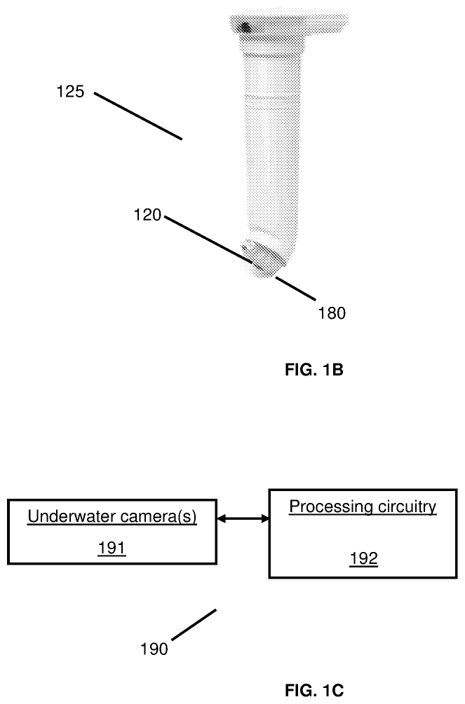

FIG. 1A illustrates an embodiment of a computerized system 100 which can be used to perform one or more of the methods described hereinafter. As shown, system 100 comprises at least one processing circuitry 110. The processing circuitry 110 includes one or more processors and one or more memories.

It is to be noted that while the present disclosure refers to the (at least one) processing circuitry 110 being configured to perform various functionalities and/or operations, the functionalities/operations can be performed by the one or more processors of the processing circuitry 110 in various ways. By way of example, the operations described hereinafter can be performed by a specific processor, or by a combination of processors. The operations described hereinafter can thus be performed by respective processors (or processor combinations) in the processing circuitry 110, while, optionally, at least some of these operations may be performed by the same processor. The present disclosure should not be limited to be construed as one single processor always performing all the operations.

System 100 and/or the at least one processing circuitry 110 can be used to perform various methods with respect to one or more swimming pools, as further detailed hereinafter.

As mentioned above, the processing circuitry 110 encompasses a single processor or multiple processors, which may be located in the same geographical zone, or may, at least partially, be located in different zones, and may be able to communicate together. Therefore, when referring to operations performed by the (at least one) processing circuitry 110, this includes various different possible configurations, as detailed hereinafter. Note that applies also to other processing circuitries mentioned hereinafter, such as processing circuitry 192.

This can include operations performed by the processing circuitry 110 located in a unit within the swimming pool(s) and/or in the vicinity of the swimming pool(s), and/or operations performed remotely by one or more remote processing circuitries in communication (using wireless or wire communication, such as Wifi, LAN, etc.) with a unit located within the swimming pool(s) and/or in the vicinity of the swimming pool(s).

For example, this can include a configuration in which at least part of the operations described hereinafter are performed locally (by one or more processors of a unit located within the swimming pool(s) and/or in the vicinity of the swimming pool(s)) and/or remotely (by one or more processors of a cloud, remote server, remote computerized system(s) including one or more processing circuities, etc.)

This can also include a configuration in which a processing circuitry of a unit located within the swimming pool(s) and/or in the vicinity of the swimming pool(s)) transmits (or triggers transmission through any adapted communication channel) data collected by one or more sensors (see reference 130), or any other relevant additional data, to one or more remote processing circuitries (e.g., cloud, remote servers, etc.), which perform one or more of the operations described hereinafter.

This can also include any other adapted configuration in which one ore more of the operations (as described hereinafter) can be performed by one or more processors located at the same place or at different locations.

According to some embodiments, at least part of the system 100 can be embedded in an underwater unit (also called pool unit 125), located within a swimming pool.

An example of such an underwater unit is depicted as reference 125 in FIG. 1B. The underwater unit 125 can be affixed e.g., to a wall and/or to a edge of a swimming pool. At least part of the underwater unit 125 is immersed underwater.

An example of such an underwater unit is described in U.S. Ser. No. 17/849,883 incorporated herein by reference in its entirety.

As shown in FIG. 1A, system 100 can obtain data from one or more sensors 130. Note that communication can be via wires, or wireless. In particular, system 100 can obtain data from at least one underwater camera 120 (or a plurality of underwater cameras 120), operative to acquire underwater images of the swimming pool. In some embodiments, the underwater camera 120 is part of the underwater unit 125. For example, the underwater camera 120 can be located under a dome 180 (e.g., hemispherical dome) of the underwater unit 125. The immersed dome 180 is transparent and enables the underwater camera 120 to acquire underwater images of the swimming pool.

According to some embodiments, the underwater camera 120 can be a static underwater camera.

According to some embodiments, the underwater camera 120 is located inside the pool, for example on a wall of the swimming pool, or in proximity of the wall of a swimming pool.

Note that the system 100 can obtain data from additional/different underwater cameras.

In some embodiments, if a plurality of underwater cameras 120 is used to monitor the swimming pool, they may have different fields of view (which do not overlap at all) or may have a field of view which can at least partially overlap.

According to some embodiments, system 100 can obtain data from at least one above-water camera(s) 115. The above-water camera 115 can acquire images of the surface of the swimming pool, which can be communicated to the system 100.

According to some embodiments, system 100 can obtain, from additional sensors 118, data from, for example, (but not limited to): a temperature sensor, a pressure sensor, a pH sensor, a motion sensor, etc. These sensors 118 can provide data informative of the swimming pool. These sensors 118 can be located within the swimming pool, or in proximity to the swimming pool.

According to some embodiments, system 100 can control operation of at least one of the sensor(s) 130. In particular, it can send commands to one or more of the sensor(s) 130.

As visible in FIG. 1A, according to some embodiments, system 100 is operatively coupled to the swimming pool's cleaning machinery 150. The swimming pool's cleaning machinery 150 includes the various devices which can be used (alone or in combination) to clean the swimming pool.

In particular, system 100 can be operatively coupled to a mobile cleaning device 131 operative to clean the swimming pool. The mobile cleaning device corresponds typically to the cleaning robot commonly present in most swimming pools.

According to some embodiments, system 100 is operative to monitor operation of the mobile cleaning device 131. This monitoring enables generating feedback informative of the performance of the mobile cleaning device 131 to achieve its cleaning mission.

According to some embodiments, system 100 is operative to control operation of the mobile cleaning device 131. This can include controlling the path of the mobile cleaning device 131 and/or the cleaning operations performed by the mobile cleaning device 131.

According to some embodiments, system 100 is operative to control operation of cleaning device(s) of the swimming pool, such as cleaning pump(s) 135, filtration system(s), or other static cleaning devices, etc.

According to some embodiments, system 100 is operative to control operation of cleaning device(s) 136 of the swimming pool which uses chemicals. These chemicals are delivered within the water, for example in order to annihilate various bacteria present in the water.

As explained hereinafter in the specification, system 100 can process data collected by one or more of the sensors 130, in order to provide data which are usable to facilitate maintenance (such as cleaning) of the swimming pool. In some embodiments, the data generated by the system 100 can include various analytics informative of the water condition and/or activity within the swimming pool.

The various data generated by the system 100 can be transmitted in some embodiments to other devices 150 using a wire or wireless communication network 140. In some embodiments, the data generated by the system 100 can be transmitted to a user's device 155 (such as a cellular phone, a home alerting unit, a smartwatch, a computer, etc.).

In some embodiments, the processing circuitry 110 communicates with an antenna 151, which can be used to transmit/receive data remotely.

As visible in FIG. 1A, the processor of the processing circuitry 110 can be configured to implement at least one machine learning model 160. In some embodiments, the machine learning model 160 can include a neural network (NN). In some embodiments, the machine learning model 160 can include a deep neural network (DNN).

In particular, the processor can execute several computer-readable instructions implemented on a computer-readable memory comprised in the processing circuitry, wherein execution of the computer-readable instructions enables data processing by the machine learning model 160. As explained hereinafter, the machine learning model enables processing of data provided by one or more of the sensors 130, for outputting data informative of water condition in the swimming pool (location of debris, turbidity, level of water, etc.), and/or data informative of an activity within the swimming pool (activity of the cleaning robot, human activity, etc.).

Note that in some embodiments, the processor of processing circuitry 110 can be configured to implement a plurality of different machine learning models 160. Each machine learning model can therefore be trained to perform a different detection task (for example, one machine learning model is used to determine turbidity, another one is used to detect/characterize dirt elements, another one to detect level of water, another one to detect the cleaning robot, another one to determine human activity, etc.).

By way of non-limiting example, the layers of the machine learning model 160 can be organized in accordance with Convolutional Neural Network (CNN) architecture, Recurrent Neural Network architecture, Recursive Neural Networks architecture, Generative Adversarial Network (GAN) architecture, or otherwise. In some embodiments, at least some of the layers can be organized in a plurality of DNN sub-networks. Each layer of the DNN can include multiple basic computational elements (CE), typically referred to in the art as dimensions, neurons, or nodes.

Generally, computational elements of a given layer can be connected with CEs of a preceding layer and/or a subsequent layer. Each connection between a CE of a preceding layer and a CE of a subsequent layer is associated with a weighting value. A given CE can receive inputs from CEs of a previous layer via the respective connections, each given connection being associated with a weighting value which can be applied to the input of the given connection. The weighting values can determine the relative strength of the connections and thus the relative influence of the respective inputs on the output of the given CE. The given CE can be configured to compute an activation value (e.g., the weighted sum of the inputs) and further derive an output by applying an activation function to the computed activation. The activation function can be, for example, an identity function, a deterministic function (e.g., linear, sigmoid, threshold, or the like), a stochastic function, or other suitable function. The output from the given CE can be transmitted to CEs of a subsequent layer via the respective connections. Likewise, as above, each connection at the output of a CE can be associated with a weighting value which can be applied to the output of the CE prior to being received as an input of a CE of a subsequent layer. Further to the weighting values, there can be threshold values (including limiting functions) associated with the connections and CEs.

System 100 can be used to perform one or more of the methods described hereinafter.

According to some embodiments, various operations described hereinafter in the different embodiments can be performed remotely, for example by exchanging data with a remote server (e.g., cloud). At least part of the computerized system 100 can therefore correspond to a remote server, which receive data of the sensors 130 using a network such as Internet. According to some embodiments, part of the operations described hereinafter are performed remotely by a remote server (e.g., cloud) and part of the operations described hereinafter are performed by a computerized system located physically in the vicinity of the swimming pool.

According to some embodiments, all operations can be performed locally by a computerized system 100 physically located in the vicinity of the swimming pool (this is however not limitative).

According to some embodiments, system 100 is part of a system 190 for detecting human drowning (see FIG. 1C). An example of such a system 190 is described in U.S. Pat. No. 11,216,654 of the Applicant, which is incorporated hereinafter in its entirety.

The system 190 for detecting human drowning can include one or more underwater cameras 191, and at least one processing circuitry 192 which processes the underwater images using a deep learning model, to detect human candidates in the images, and detect human drowning in the absence of motion of the human candidates. The various functions performed by the system 100 can correspond to additional functions provided by the system 190 for detecting human drowning (in addition to the human drowning detection and alerting functions already provided by the system 190). In particular, system 100 can rely on the underwater cameras 191 already used by the system 190, and on the processing circuitry 192 already present in the system 190.

In some embodiments, the computerized system 100 can include the sensor(s) 130 or can be operatively coupled to them.

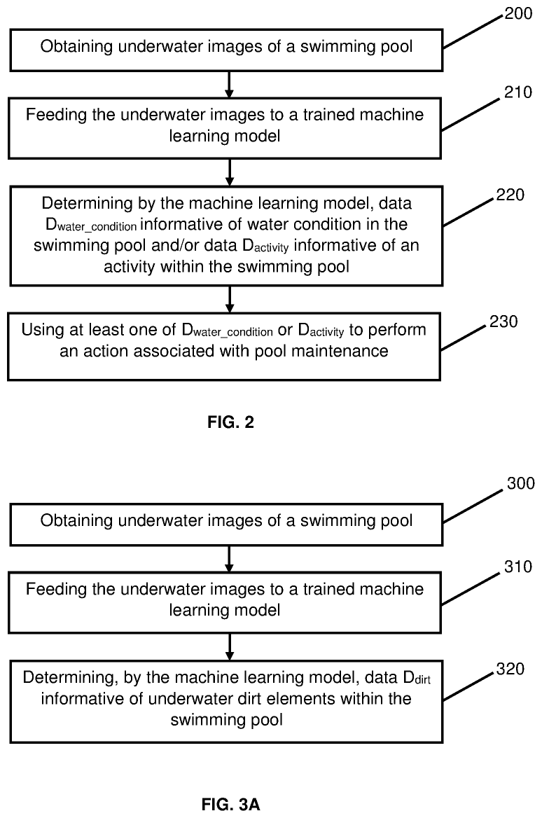

Attention is now drawn to FIG. 2.

The method of FIG. 2 includes obtaining (operation 200) underwater images of a swimming pool acquired by at least one underwater camera 120.

The method further includes feeding (operation 210) the underwater images (or data informative thereof, such as the underwater images after some image processing) to at least one machine learning model (see reference 160 in FIG. 1A—or to a plurality of machine learning models. Note that examples thereof have been provided above) to determine (operation 220) data D_{water_condition} informative of water condition in the swimming pool and/or data D_{activity} informative of an activity within the swimming pool. The data D_{water_condition} informative of water condition in the swimming pool and/or data D_{activity} are output by the at least one machine learning model.

Image processing of the underwater images can include e.g., noise reduction, sharpening, filtering, etc. (this is not limitative).

According to some embodiments, the output of the machine learning model can be used together with data provided by a computer vision algorithm used on the underwater images (e.g., blob detection algorithm, segmentation algorithm, shape detection algorithm, etc.) to determine D_{water_condition} and/or D_{activity}.

Data D_{water_condition} informative of water condition in the swimming pool can include at least one of: data informative of underwater dirt elements (e.g., debris, leaves, algae, etc.) present in the swimming pool (location of the dirt elements, amount of the dirt elements, type of the dirt elements, etc.), data informative of the turbidity of the water of the swimming pool (turbidity is the measure of relative clarity of a liquid—it is an optical characteristic of water, and is a measurement of the amount of light that is scattered by material in the water when a light is shone through the water sample), level of the water of the swimming pool, etc.

Data D_{activity} informative of an activity within the swimming pool can include at least one of: data informative of an activity of the mobile cleaning device 131 (e.g., position of the mobile cleaning device 131 over time, time spent by the mobile cleaning device 131 at each of a plurality of locations, position of the mobile cleaning device 131 relative to predefined segments of the pool (floor, walls, etc,), etc.), data informative of human activity in the swimming pool (number of bathers, frequency of use of the swimming pool, ages of swimmers, etc.).

Note that the machine learning model 160 has been previously trained to output data D_{water_condition} and/or data D_{activity}. The training can include supervised learning/semi-supervised learning, in which a training set of images is fed to the machine learning model, together with a label provided e.g., by an operator. The label reflects the desired output (target) for data D_{water_condition} and/or data D_{activity} for each image of the training set.

The data D_{water_condition} and/or data D_{activity} are usable to facilitate maintenance of the swimming pool. In particular, these data can be used by the pool's owner to determine when the pool requires cleaning.

According to some embodiments, the method of FIG. 2 includes using (operation 230) at least one of data D_{water_condition} and/or data D_{activity} to perform an action associated with maintenance of the pool.

According to some embodiments, the action includes outputting at least part of the data D_{water_condition} and/or data D_{activity} on a display device (e.g., a screen of a cellular phone of a user, or a screen of a home unit of the user, or of another device 155 of the user).

In some embodiments, the action can include using data D_{water_condition} and/or data D_{activity} to control automatic cleaning of the pool, by controlling operation of the pool cleaning machinery 150 (such as, but not limited to, the mobile cleaning device 131). This will be further discussed hereinafter.

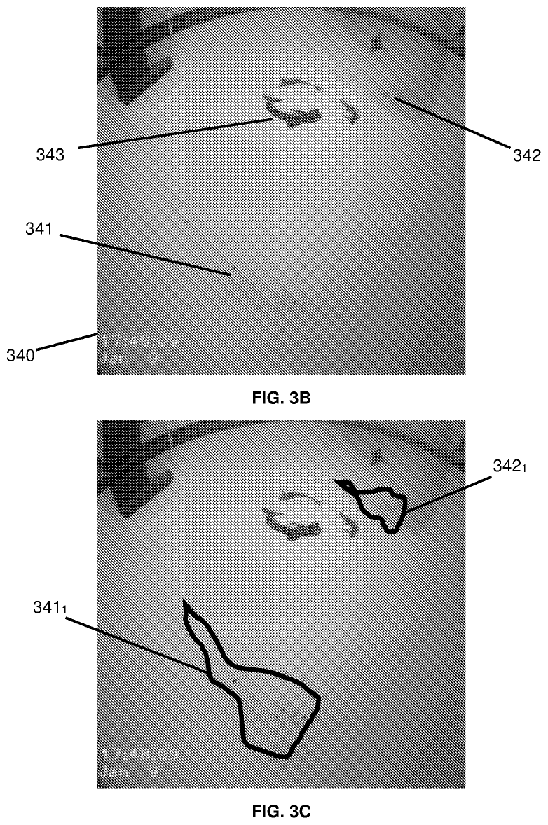

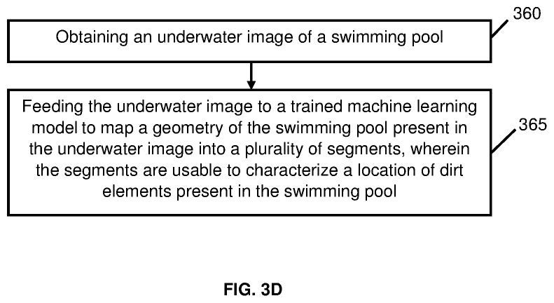

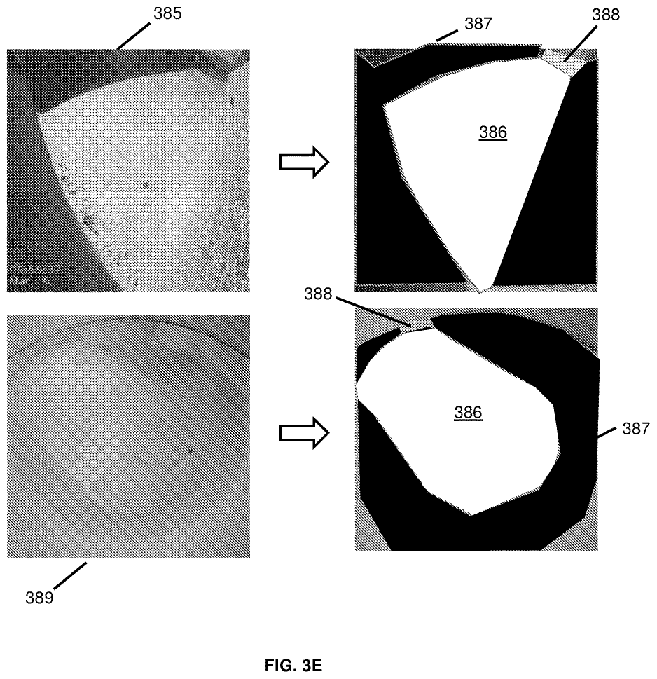

Attention is now drawn to FIG. 3A.

The method of FIG. 3A enables determining data informative of the location of underwater dirt elements present within the swimming pool, using underwater images.

The method includes obtaining (operation 300) one or more underwater images of a swimming pool acquired by at least one underwater camera 120.

The method further includes feeding (operation 310) the one or more underwater images (or data informative thereof, such as the underwater images after some image processing) to a trained machine learning model (for example, machine learning model 160—or a different machine learning model implemented by the processing circuitry 110). Examples of types of machine learning models have been provided above with respect to reference 160.

Image processing of the underwater images can include e.g., noise reduction, sharpening, filtering, etc. (this is not limitative).

The method further includes determining (operation 320), by the machine learning model, data D_{dirt} informative of underwater dirt elements within the swimming pool.

According to some embodiments, data D_{dirt} includes at least one of: location of the dirt elements within the swimming pool, amount of the dirt elements at each location, type of the dirt elements, etc.

According to some embodiments, the location of the dirt elements is an estimate of the spatial location of the dirt elements in a three-dimensional referential.

According to some embodiments, the location of the dirt elements is defined with respect to predefined sections (segments) of the swimming pool. These sections (segments) map the geometry of the pool in the image. For example, the predefined sections (segments) include floor (bottom) of the pool, left wall of the pool, right wall of the pool, front wall of the pool, rear wall of the pool, and the steps of the pool. The machine learning model is trained to output in which of these predefined sections (segments) of the pool the dirt elements are located.

As a non-limitative example, the machine learning model can output that dirt elements have been identified on the right wall of the pool.

The machine learning model has been previously trained to determine data D_{dirt} based on underwater image(s).

According to some embodiments, the machine learning model has been trained to differentiate between dirt elements and non-dirt elements in underwater images of a swimming pool. This enables preventing the machine learning model from erroneously detecting elements (such as features of the pool itself) present in the swimming pool, which do not correspond to dirt elements.

A non-limitative example is provided with reference to FIG. 3B, which depicts an underwater image 340 of the floor of a pool. Dirt elements are present at two different areas (341 and 342) on the floor of the pool. In addition, the floor of the pool includes pool features (painted dolphins 343), which do not correspond to dirt elements.

Since the machine learning model has been trained to differentiate between dirt elements and non-dirt elements in underwater images of a swimming pool, it outputs a first bounding box 341₁, corresponding to the dirt elements present in the area 341, and a second bounding box 342₁, corresponding to the dirt elements present in the area 342. However, the machine learning model has not output a bounding box for the painted dolphins 343, since it has detected that these painted dolphins do not correspond to dirt elements.

The training of the machine learning model can include supervised learning/semi-supervised learning, in which a training set of underwater images is fed to the machine learning model, together with a label provided e.g., by an operator.

At least some of the underwater images of the training set include dirt elements. According to some embodiments, the training set of underwater images includes underwater images of pools in which non-dirt elements are present on the floor and/or walls of the pool (see e.g., FIG. 3B), in order to train the machine learning model to avoid detecting these elements as dirt elements.

The label indicates the location of the dirt elements in the image (using e.g., a bounding box). In some embodiments, the label can indicate in which of the predefined sections (segments) of the swimming pool the dirt elements are located (e.g., floor of the pool, left wall of the pool, right wall of the pool, front wall of the pool, rear wall of the pool, steps of the pool). These sections (segments) map the geometry of the pool in the image.

The label can also indicate the location of the non-dirt elements in the underwater images of the training set, such as pool features (e.g., dolphins), shades of object, etc.

The label can also indicate, in some embodiments, the type of dirt elements (debris, leaves, algae, etc.), and the amount of dirt elements (the amount can be classified in categories such as high concentration of dirt elements, medium concentration of dirt elements, low concentration of dirt elements-note that these categories are not limitative), etc.

The training set of underwater images, together with the labels, are fed to the machine learning model for its training (using techniques such as Backpropagation—this is not limitative).

Attention is now drawn to FIG. 3D.

The method of FIG. 3D can be used to map the geometry of the swimming pool, using at least one underwater image.

The method includes obtaining (operation 360) at least one underwater image of a swimming pool acquired by at least one underwater camera 120.

The method further includes feeding (operation 370) the underwater image (or data informative thereof, such as the underwater image after some image processing) to a trained machine learning model (for example, machine learning model 160—or a different machine learning model implemented by the processing circuitry 110), to map a geometry of the swimming pool present in the underwater image into a plurality of segments. Note that the segments are usable to characterize a location of dirt elements present in the swimming pool, as explained hereinafter.

Image processing of the underwater image can include e.g., noise reduction, sharpening, filtering, etc. (this is not limitative).

According to some embodiments, the output of the machine learning model can be used together with data provided by a computer vision algorithm used on the underwater images (e.g., blob detection algorithm, segmentation algorithm, shape detection algorithm, etc.) to determine the segments.

With the above method, the geometry of the inner part of the pool is therefore mapped using the predefined segments.

The method therefore provides a computerized automatic segmentation of the inner part of the pool.

For example, the predefined segments include floor (bottom) of the pool, wall of the pool (such as left wall of the pool, right wall of the pool, front wall of the pool, rear wall of the pool), steps of the pool, etc.

FIG. 3E illustrates a first example in which an underwater image 385 of a first swimming pool is processed by the machine learning model to map a geometry of the swimming pool present in the underwater image 385 into three segments: floor 386 of the pool, walls 387 of the pool and steps 388 of the pool. The same applies to the underwater image 389 of a second swimming pool.

Note that the method of FIG. 3D can be repeated periodically (from time to time). This can be used to enhance the segmentation. This is not limitative.

According to some embodiments, the machine learning model used in the method of FIG. 3D is a deep convolutional neural network. In some embodiments, the deep convolutional network is trained and used to perform a semantic segmentation.

According to some embodiments, the method of FIG. 3D can be performed on a low-resolution image. As a consequence, it can be performed using cloud computing, or with a processing circuitry that can be located in proximity to the underwater camera. Note that in order to improve accuracy, the method of FIG. 3D can be performed at a remote location, such as on a server on a cloud.

According to some embodiments, the segmentation/mapping of the method of FIG. 3D and can be done in a coarse-to-fine manner.

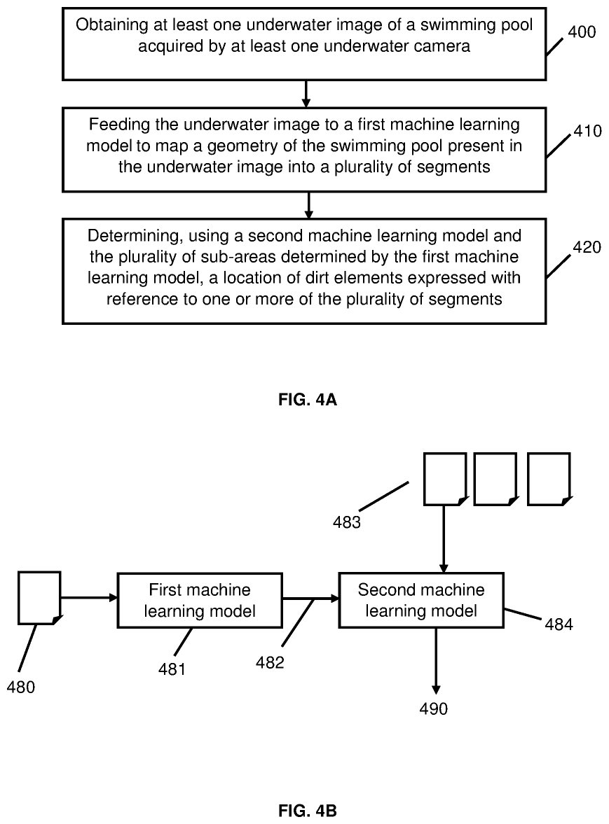

Attention is now drawn to FIGS. 4A and 4B, which combine the methods of FIGS. 3A and 3D.

The method includes obtaining (operation 400) at least one underwater image 480 of a swimming pool acquired by at least one underwater camera 120.

The underwater image is processed by a first machine learning model 480 to map a geometry of the pool in the image into a plurality of segments 482, in accordance with the method of FIG. 3D. Examples of machine learning models have been provided above with respect to reference 160.

The method further includes feeding (operation 410) at least one underwater image 483 (which can be different from the underwater image 480, but not necessarily), or data informative thereof (e.g., after some image processing), to a second machine learning model 484. The second machine learning model 484 can be different from the first machine learning model 481. Examples of machine learning models have been provided above with respect to reference 160.

The method uses (operation 420) the second machine learning model 484 to determine the location of the dirt elements in the underwater image 483.

The second machine learning model 484 receives data informative of the plurality of segments 482 as previously determined by the first machine learning model 481. As a consequence, it can express the location of the dirt elements with reference to one or more segments of the plurality of segments. For example, an output 490 of the method can be: “dirt elements are present on the steps of the swimming pool”. This example is not limitative.

According to some embodiments, the output of the second machine learning model can be used together with data provided by a computer vision algorithm used on the underwater images (e.g., blob detection algorithm, segmentation algorithm, shape detection algorithm, etc.) to determine the data D_{dirt}.

A report can be provided to a user. For example, a report can be displayed on a display device (e.g., screen) of a device (e.g., smartphone, home unit, computer, smartwatch, etc.) of a user. The report can include the location of the dirt elements in the swimming pool. The report can include other data, such as amount of the dirt elements, type of the dirt elements, etc. It can include recommendation of whether cleaning of the pool should be triggered, and when this should occur.

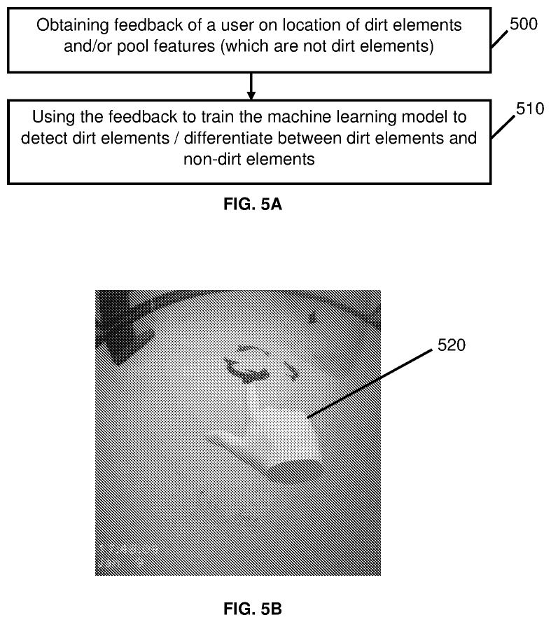

Attention is now drawn to FIGS. 5A and 5B.

The method of FIG. 5A includes obtaining (operation 500) feedback of a user on location of dirt elements and/or on location of pool features (which are not dirt elements).

For example, the feedback can be tactile feedback (see schematic representation of the hand 520 of the user on the image of the pool in FIG. 5B). Such tactile feedback can be provided by the user who draws on an image of the pool displayed on a display unit (e.g., a screen of a smartphone) the location of dirt elements and/or pool features. The user can, for example, draw a bounding box, using a tactile interaction.

The method further includes using (operation 510) the feedback to train the machine learning model to detect dirt elements. The feedback can be fed to the machine learning model to retrain it. In particular, this improves training of the machine learning model, which can learn to detect specific/new pool features (e.g., specific tiles of the pool) and/or specific/new dirt elements. It improves the capability of the machine learning model to differentiate between dirt elements and non-dirt elements.

In some embodiments, the feedback of the user can pertain to the amount of dirt elements, type of dirt elements, etc., which can be used to retrain the machine learning model.

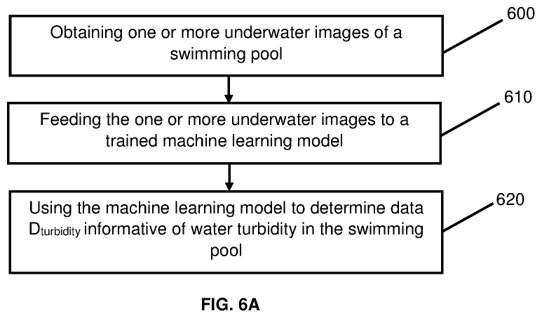

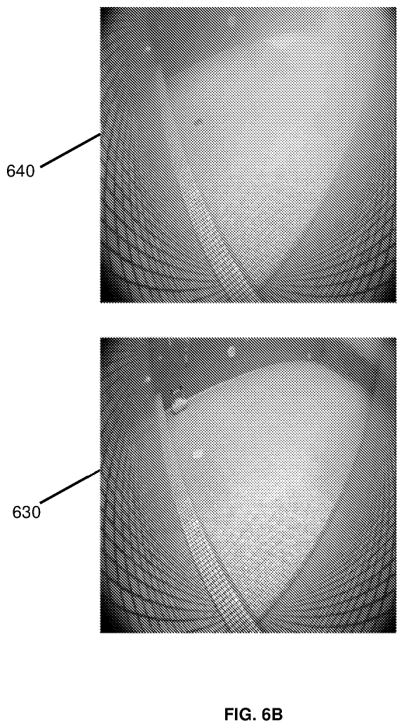

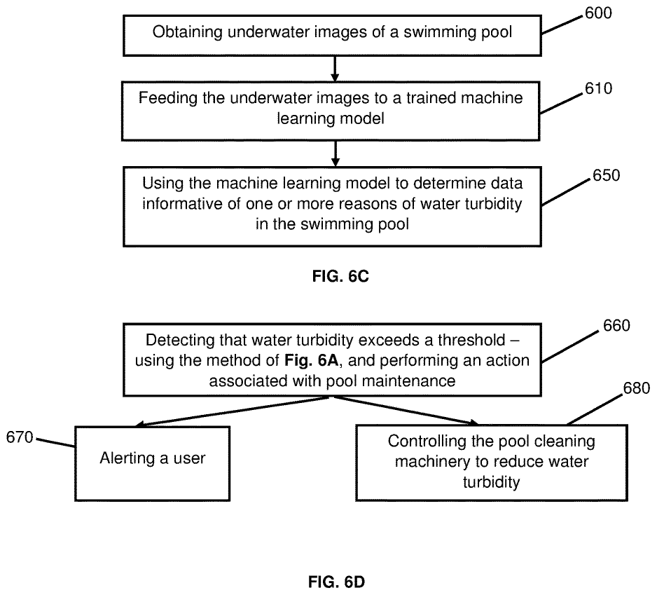

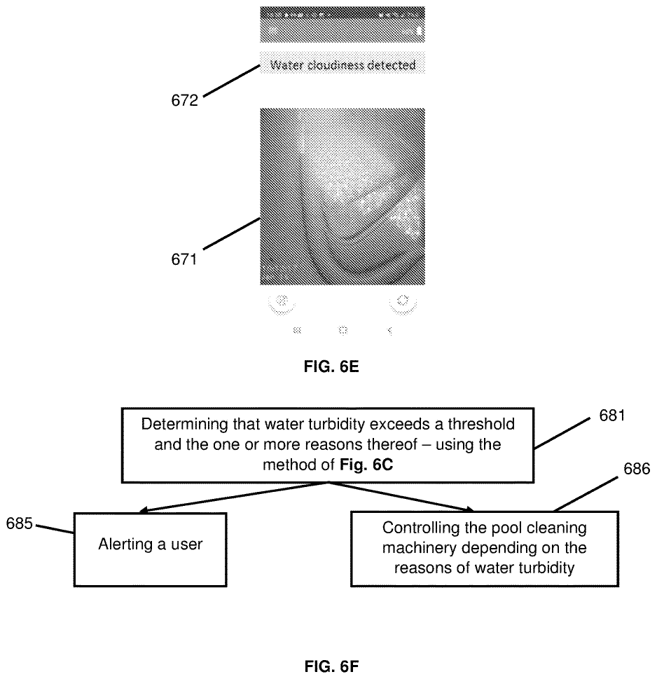

Attention is now drawn to FIG. 6A.

The method of FIG. 6A enables determining data informative of water turbidity in a swimming pool.

The method includes obtaining (operation 600) one or more underwater images of a swimming pool acquired by at least one underwater camera 120.

The method further includes feeding (operation 610) the one or more underwater images (or data informative thereof, such as after some image processing) to a trained machine learning model (for example, machine learning model 160—or a different machine learning model implemented by the processing circuitry 110). The machine learning model used in this method can be e.g., a deep neural network, such as a conventional neural network (CNN). This is not limitative (see other examples above with respect to reference 160).

Image processing of the underwater images can include e.g., noise reduction, sharpening, filtering, etc. (this is not limitative).

The method further includes using (operation 620) the machine learning model to determine data D_{turbidity} informative of water turbidity in the swimming pool.

In some examples, data D_{turbidity} can include a level of turbidity. The level of turbidity can be expressed according to a predefined scale, such as, but not limited to, “low”, “medium” and “high”, or according to percentages (or any other adapted scale).

In some examples, data D_{turbidity} can include includes one or more values of turbidity expressed in Formazin Nephelometric Units (FNU) or in Nephelometric Turbidity Units (NTU).

In some examples, the machine learning model directly outputs the level of turbidity. In some examples, the level of turbidity is expressed for the whole image. In other examples, the machine learning model outputs for each given area of a plurality of areas of the underwater image (identified by the machine learning model), a given level of turbidity associated with the given area.

In some examples, the machine learning model directly outputs, for each underwater image, the one or more turbidity values expressed in FNU or NTU. Note that the turbidity value(s) can be expressed, for each underwater image of the training set, as a turbidity value (or range of values) for the whole underwater image, or can include a plurality of turbidity values (each given area of a plurality of areas identified by the machine learning model in each underwater image is assigned with corresponding given turbidity value(s)).

In some examples, the machine learning model can output both a level of turbidity (expressed according to a predefined scale) and turbidity values (expressed in FNU or NTU). In some examples, a first machine learning model is used to determine a level of turbidity (expressed according to a predefined scale) and a second machine learning model is used to determine turbidity values (expressed in FNU or NTU).

In some examples, the machine learning model determines, in each underwater image, one or more areas in which turbidity (meeting a criterion, such as a turbidity which is above a certain level or threshold) is present. Then, the one or more areas are used to determine data D_{turbidity}. In some examples, the dimensions (e.g., height, width, surface area) of the one or more areas can be converted into level(s) of turbidity. For example, for dimension(s) of an area in a first range, a first level of turbidity is declared (e.g., “low”), for dimension(s) of an area in a second range, a second level of turbidity is declared (e.g., “medium”), and for dimension(s) of an area in a third range, a third level of turbidity is declared (e.g., “high”). This is not limitative. Note that the conversion from the dimension(s) of an area into the level of turbidity can be based on heuristics, experimental data and/or simulated data.

In some examples, the dimensions of the one or more areas can be converted into one or more values of turbidity expressed in Formazin Nephelometric Units (FNU) or in Nephelometric Turbidity Units (NTU). The conversion can use a function (and/or a model) which converts the dimensions of the one or more areas into values expressed in FNU or NTU. This function (or mode) can be built using experimental data (and/or simulated data, in which it is attempted to fit a function correlating the dimensions of the one or more areas (as extracted from the areas identified by the machine learning model in the underwater images) to the FNU or NTU values (obtained using one or more sensor(s) of the swimming pool in which the underwater images have been acquired).

Note that the various modes described above can be combined. For example, the machine learning model can both output estimated value(s) of turbidity expressed in FNU or NTU and/or level of turbidity expressed according to a predefined scale and/or areas of the image which can be used (as explained above) to determine value(s) of turbidity expressed in FNU or NTU (and/or to determine level of turbidity expressed according to a predefined scale).

The proposed solution enables determining the level of turbidity and/or turbidity values (expressed in FNU/NTU) using computer vision, without requiring prior art expensive sensors/systems used to determine turbidity.

In some examples, when the turbidity value is above a threshold (which can be provided by regulations-nowadays in some countries, the maximal acceptable turbidity value is 0.6 NTU, this is however not limitative), an alarm can be raised (e.g., visual and/or audio and/or textual alarm).

According to some embodiments, the output of the machine learning model can be used together with data provided by a computer vision algorithm used on the underwater images (e.g., blob detection algorithm, segmentation algorithm, shape detection algorithm, etc.) to determine data D_{turbidity}.

An example of water turbidity is provided in FIG. 6B. In the bottom image 630 of the pool, the water is clean, and the water turbidity is below a threshold. In the upper image 640 of the same pool, the water turbidity is above a threshold (the threshold can be indicative of the fact that the pool must be cleaned to reduce turbidity).

The training of the machine learning model can include supervised learning/semi-supervised learning, in which a training set of underwater images is fed to the machine learning model, together with a label provided e.g., by an operator.

In some examples in which the machine learning model is trained to determine areas in which turbidity (above a certain level or value expressed in FNU or NTU) is present, the label can indicate, in each underwater image of the training set, the position (e.g., bounding box) of the area(s) in which turbidity is above this level or value. The trained machine learning model is then able to determine, in underwater images, the areas of the underwater images in which turbidity is above the certain threshold or value.

In some examples in which the machine learning model is trained to directly output the level of turbidity (expressed according to a predefined scale), the labels indicate the level of water turbidity in each underwater image of the training set.

In some examples in which the machine learning model is trained to directly output the turbidity value (expressed in FNU or NTU), the labels indicate, for each underwater image, the corresponding turbidity value(s) expressed in FNU or NTU. Note that the corresponding turbidity value(s) can be expressed, for each underwater image of the training set, as a turbidity value (or range) for the whole underwater image, or can include a plurality of turbidity values (each given area of a plurality of areas of each underwater image is assigned with a turbidity value). The turbidity value(s) in each underwater image can be obtained using existing sensors present in the swimming pool.

The training set of underwater images, together with the labels, are fed to the machine learning model for its training (using techniques such as Backpropagation).

Note that the method of FIG. 6A enables determining water turbidity without requiring using a pattern/indicator located at the bottom of the pool.

FIG. 6C illustrates additional data that can be provided by the machine learning model.

As visible in FIG. 6C, the method includes feeding the one or more underwater images to the machine learning model to determine data informative of one or more reasons for water turbidity in the swimming pool (see operations 610, 620 and 650). In some embodiments, for a predefined (e.g., by a user) list of reasons of water turbidity, the machine learning model outputs, for a given underwater image, a probability associated with each reason on the list.

The list of reasons for water turbidity can include at least one of: improper levels of chlorine, imbalanced pH, imbalanced alkalinity, high calcium hardness (CH) levels, a faulty or clogged filter, early stages of algae, ammonia, or debris, etc. This list is not limitative.

Training of the machine learning model can include supervised learning/semi-supervised learning, in which a training set of underwater images is fed to the machine learning model, together with a label provided e.g., by an operator. The label indicates the one or more reasons for water turbidity (or a probability for each reason) in each underwater image of the training set. The label can also include the level of water turbidity in each image.

The training set of underwater images, together with the labels, are fed to the machine learning model for its training (using techniques such as Backpropagation).

According to some embodiments, the output of the machine learning model can be used together with data provided by a computer vision algorithm used on the underwater images (e.g., blob detection algorithm, segmentation algorithm, shape detection algorithm, etc.) to determine the reasons for turbidity.

As shown in FIG. 6D, detection of water turbidity in the pool can be used for improving pool maintenance.

When it is detected that water turbidity exceeds a threshold (operation 660—using the method of FIG. 6A which enables determining the level of water turbidity), the method can include performing an action associated with pool maintenance.

In some embodiments, the action can include alerting a user (operation 670). This can include triggering a visual and/or audio alert. In some embodiments, this can include displaying (see reference 672) on a display device, that the water turbidity exceeds a threshold. In some embodiments, the alerting can include displaying to the user an underwater image 671 of the pool in which water turbidity exceeds the threshold.

Once the user receives this alert, he can decide to manually trigger cleaning of the pool, using the pool cleaning machinery 150.

According to some embodiments, when it is detected that water turbidity exceeds a threshold, the action can include controlling (operation 680) the pool cleaning machinery 150 to reduce water turbidity (i.e., by remote control). For example, a command can be sent to the cleaning robot and/or to the cleaning pump and/or to a device enabling delivering chemical(s) within the pool and/or to the main filtration system of the pool, in order to reduce water turbidity. The pool cleaning machinery can be activated until it is detected (using the method of FIG. 6A) that water turbidity is below the threshold.

In some embodiments, a command can be sent to variable-speed pool pump(s) to activate them, thereby reducing water turbidity.

Contrary to prior art systems, which operate according to a fixed predefined schedule, the method can control the pool cleaning machinery to reduce water turbidity only when it is actually needed, thereby optimizing pool maintenance.

In a variant of the method of FIG. 6D (see FIG. 6F), when it is detected that water turbidity exceeds a threshold, the one or more reasons for such high water turbidity are also determined (operation 681—using the method of FIG. 6C). An action is then performed, which can include triggering an alert to a user (operation 685). The alert can be indicative of the fact that the water turbidity exceeds a threshold. The alert can also include the one or more reasons for such high water turbidity.

Assume that the pool cleaning machinery includes a plurality of cleaning devices (cleaning robot, cleaning pump, chemical devices, etc.). The method can include sending (operation 686) a command to a given cleaning device selected among the plurality of the cleaning devices, for cleaning the pool, wherein the given cleaning device is selected based on data informative of one or more reasons for water turbidity in the swimming pool.

For example, assume that it has been detected that the high level of water turbidity is due to an imbalanced pH. The method can include sending a command to a chemical device to deliver, within the pool, the required amount of chemicals which enables restoring the imbalanced pH to a balanced pH.

In another example, assume that it has been detected that the high level of water turbidity is due to the presence of algae. The method can include sending a command to the cleaning robot to remove the algae. Note that location of the algae can be determined using the method of FIG. 3A or 4A.

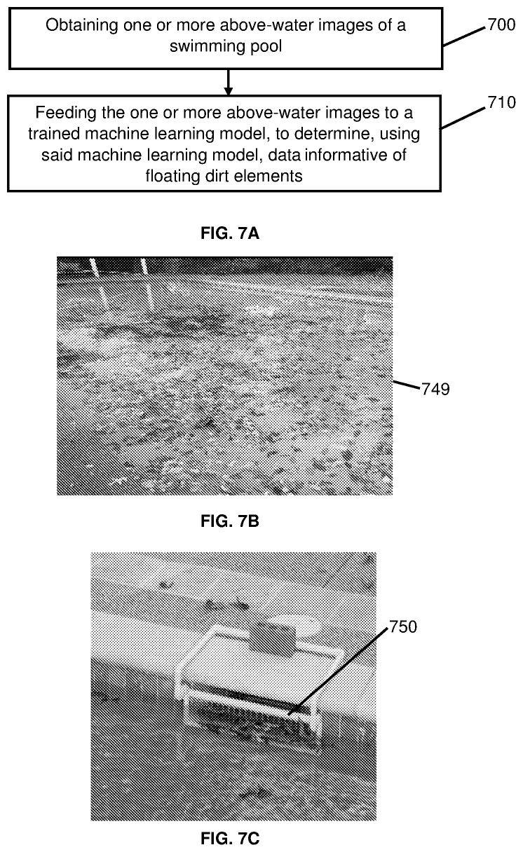

Attention is now drawn to FIG. 7A.

The method includes obtaining (operation 700) one or more above-water images of a swimming pool acquired by at least one above-water camera 115. In some embodiments, the above-water camera 115 is located slightly above the water level of the pool and acquires above-water images of the pool.

The method further includes feeding (operation 710) the one or more above-water images (or data informative thereof, such as the above-water image after some image processing) to a trained machine learning model (for example, machine learning model 160—or a different machine learning model implemented by the processing circuitry 110), to determine, using the machine learning model, data informative of floating dirt elements. Examples of machine learning model(s) 160 have been provided above.

Image processing of the above-water images can include e.g., noise reduction, sharpening, filtering, etc. (this is not limitative).

According to some embodiments, the output of the machine learning model can be used together with data provided by a computer vision algorithm used on the above-water images (e.g., blob detection algorithm, segmentation algorithm, shape detection algorithm, etc.) to determine data informative of floating dirt elements.

Data informative of floating dirt elements can include the location of floating dirt elements, the amount of floating dirt elements (in some embodiments, per location or per area), types of floating dirt elements, etc.

Training of the machine learning model can include supervised learning/semi-supervised learning, in which a training set of above-water images of pool(s) is fed to the machine learning model, together with a label provided e.g., by an operator. At least some of the above-water images include floating dirt elements.

According to some embodiments, the training set of above-water images of pool(s) include images of pools in which floating non-dirt elements (e.g., toys, etc.) are present, in order to train the machine learning model to avoid detecting these elements as floating dirt elements.

The label indicates the location of the floating dirt elements in the image (using e.g., a bounding box).

The label can also indicate the location of the floating non-dirt elements in the images of the training set.

The label can also indicate, in some embodiments: the type of floating dirt elements (debris, leaves, algae, etc.), the amount of floating dirt elements (the amount can be classified in categories such as high concentration of dirt elements, medium concentration of dirt elements, low concentration of dirt elements-note that these categories are not limitative), etc.

The training set of above-water images, together with the labels, are fed to the machine learning model for its training (using techniques such as Backpropagation).

FIG. 7B illustrates an above-water image 749 of the pool which can be processed by the machine learning model to detect floating dirt element(s).

According to some embodiments, at least one of the above-water images includes an image of the skimmer 750 of the pool (see FIG. 7C). The machine learning model can detect, in the image, the presence of dirt elements which obstructs the skimmer (the dirt elements can be present in the skimmer, or in close vicinity of the skimmer). If the amount of obstructing dirt elements is above a threshold, this can be used to perform an action associated with pool maintenance, such as raising an alert to the user that the skimmer needs to be cleaned. Note that, in some embodiments, the machine learning model can be trained to detect the location of the skimmer on the images (this is further discussed hereinafter).

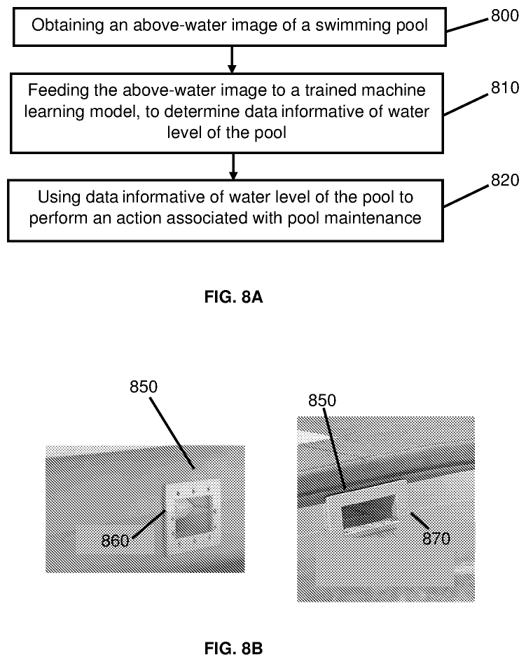

Attention is now drawn to FIGS. 8A and 8B.

The method includes obtaining (operation 800) an above-water image of a swimming pool acquired by at least one above-water camera 115.

The method further includes feeding (operation 810) the above-water image (or data informative thereof, such as the above-water image after some image processing) to a trained machine learning model (for example, machine learning model 160—or a different machine learning model implemented by the processing circuitry 110), to determine, using the machine learning model, data informative of water level of the pool.

Image processing of the above-water images can include e.g., noise reduction, sharpening, filtering, etc. (this is not limitative).

According to some embodiments, the output of the machine learning model can be used together with data provided by a computer vision algorithm used on the above-water images (e.g., blob detection algorithm, segmentation algorithm, shape detection algorithm, etc.) to determine data informative of water level.

Data informative of water level of the pool can indicate whether the water level meets a required threshold, or is below the required threshold—this therefore indicates that the pool should be refilled with water.

In some embodiments, upon detection that the water level does not meet the required threshold, the method can include performing (operation 820) an action associated with pool maintenance, such as raising an alert to the user and/or sending a command to a device to fill the swimming pool with water. The device can be, e.g., a water supply. In some embodiments, the command is transmitted to ensure that the water delivered by the filling device will make the water level reach the required threshold.

According to some embodiments, the method comprises feeding the above-water image to the machine learning model to detect that the water level of the pool is above a threshold, and upon said detection, sending a command to a device (e.g. drainage system of the pool) to remove water from the swimming pool (the command can be sent using wire or wireless communication).

In some embodiments, the above-water image used to determine the water level includes a skimmer of the pool.

Training of the machine learning model can include supervised learning/semi-supervised learning, in which a training set of above-water images of a pool is fed to a machine learning model, together with a label provided e.g., by an operator. The label indicates for each image, whether the water level meets the required threshold.

In some embodiments, an approach including at least two steps is used.

The above-water image (which includes the skimmer) is first fed to a machine learning model which detects the location of the skimmer 850 in the image (see FIG. 8B). This detection can be obtained by using a machine learning model previously trained to detect the skimmer (using a training set of images including a skimmer, and a label indicative, in each image, of the position of the skimmer). In other embodiments, an image detection algorithm can be used to detect the skimmer.

Then, an image detection algorithm (such as an edge detection algorithm) is used to determine at which location the water level crosses the skimmer in the image. If this location (see 860 in FIG. 8B) meets a criterion (for example, the upper part of the water is above the middle of the height of the skimmer), this indicates that the water level meets the required threshold, and, should this not be so, (see location 870 in FIG. 8B), this indicates that the water level does not meet the required threshold.

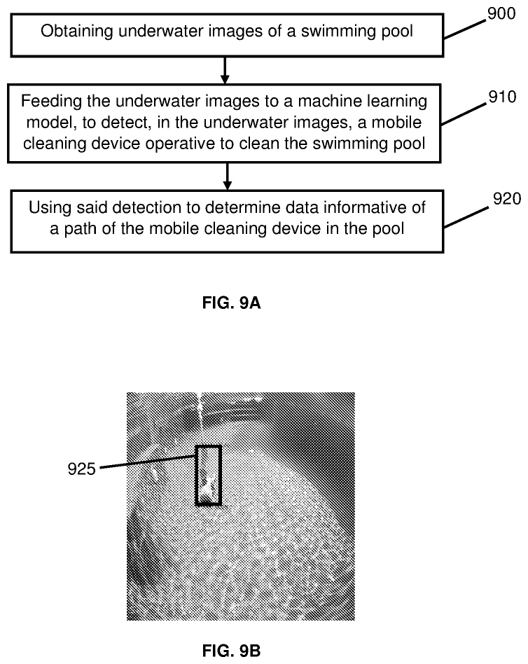

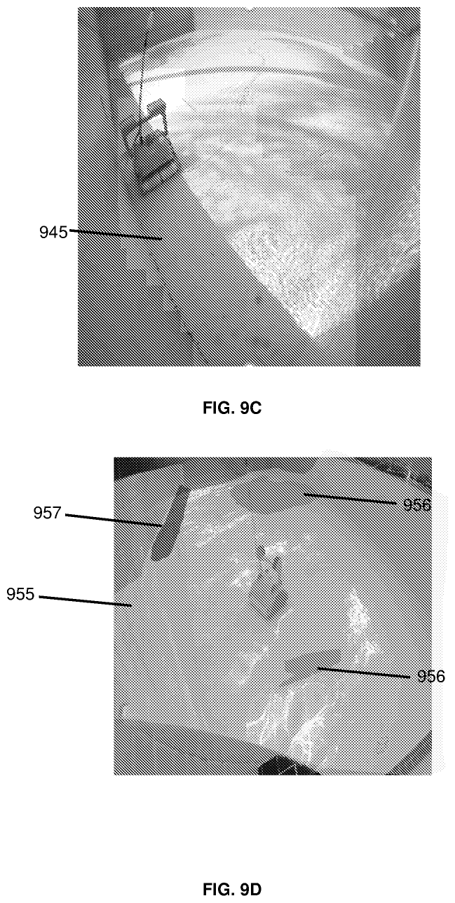

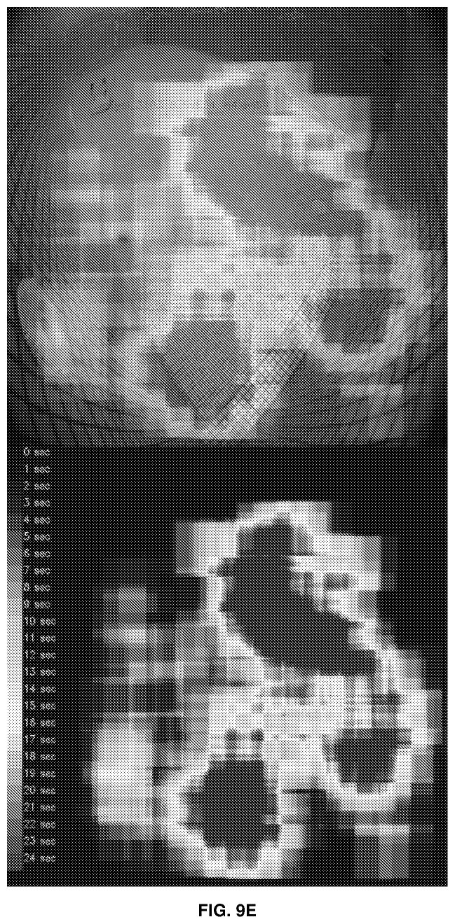

Attention is now drawn to FIG. 9A.

The method includes obtaining (operation 900) underwater images of a swimming pool acquired by at least one underwater camera 120.

The method further includes feeding (operation 910) the underwater images (or data informative thereof, such as the underwater images after some image processing) to a machine learning model (see reference 160 in FIG. 1A) to detect, in the underwater images, a mobile cleaning device (see reference 131) operative to clean the swimming pool (operation 920). The location of the mobile cleaning device is detected in the underwater images.

Image processing of the underwater images can include e.g., noise reduction, sharpening, filtering, etc. (this is not limitative).

According to some embodiments, the output of the machine learning model can be used together with data provided by a computer vision algorithm used on the underwater images (e.g., blob detection algorithm, segmentation algorithm, shape detection algorithm, etc.) to detect the mobile cleaning device.

Training of the machine learning model can include supervised learning/semi-supervised learning, in which a training set of underwater images is fed to the machine learning model, together with a label provided e.g., by an operator. The underwater images include pictures of mobile cleaning device(s) during their operation. The label indicates the position of the mobile cleaning device in each image (see bounding box 925). The training set, together with the labels, are fed to the machine learning model for its training.

Note that the use of a trained machine learning model enables to detect, with the same model, mobile cleaning devices of different brands (since the machine learning model can be trained using images of different types/brands of mobile cleaning devices).

In addition, the use of a trained machine learning model enables detecting the mobile cleaning device in the underwater images without requiring placing a marker/pattern on the mobile cleaning device.

Detection of the mobile cleaning device is used to determine data Dₚₐₜₕ informative of a path of the mobile cleaning device in the pool.

According to some embodiments, Dₚₐₜₕ includes a map informative of a coverage of the pool by the mobile cleaning device. This map (see reference 945) can be output on a display device, to a user. The user can therefore understand whether the path of the mobile cleaning device ensures sufficient coverage of the pool. This map can be overlaid on an underwater picture of the pool.

In some embodiments, the method can include raising an alert that one or more locations of the pool are not covered by the mobile cleaning robot.

In some embodiments, Dₚₐₜₕ is informative, for each position along its path, of the time spent by the mobile cleaning device at said position.

In some embodiments, Dₚₐₜₕ includes a heat map informative, for each position, of the time spent by the mobile cleaning device at said position.

This heat map indicates at which location(s) the mobile cleaning device spent too much time, or did not spend enough time, or the location(s) that the mobile cleaning device did not cover at all. This heat map is useful to assess performance of the mobile cleaning device to achieve its cleaning mission. As explained hereinafter, this heat map can be used to improve control of the path of the robot.

FIG. 9D illustrates a non-limitative example of a heat map. The heat map illustrates the coverage of the mobile cleaning device together with the time spent by the mobile cleaning device. The time is represented by three different colours: the first area 955 corresponds to a first duration, the second area 956 corresponds to a second duration (greater than the first duration) and the third area 957 corresponds to a third duration (greater than the second duration). Note that a different split of the time duration and/or a different representation can be used. In some embodiments, a different color is used in the heat map for each different period of time spent by the mobile cleaning device (see e.g., FIG. 9E).

Based on the data informative of a path of the mobile cleaning device in the pool, a report can be generated and output (e.g., to a user). The report can include at least one (this is not limitative):
a total time during which the mobile cleaning robot has operated (during a given cleaning operation of the pool). This total time can be saved, and statistics can be determined and provided to the user over a given period of time (week, month, year, etc.);
an underwater image before the pool cleaning, and after the pool cleaning, by the mobile cleaning device;
a pointer on the dirt elements before cleaning, and a pointer on the dirt elements left after cleaning by the mobile cleaning device (the pointer(s) can be overlaid on underwater images of the pool);
data informative of the parts of the pool which have not been cleaned by the mobile cleaning device—for example, the mobile cleaning device may have missed part of a wall;
data informative of the parts of the pool which have been cleaned by the mobile cleaning device with a duration below a threshold;
data informative of the parts of the pool which have been cleaned by the mobile cleaning device with a duration above a threshold.

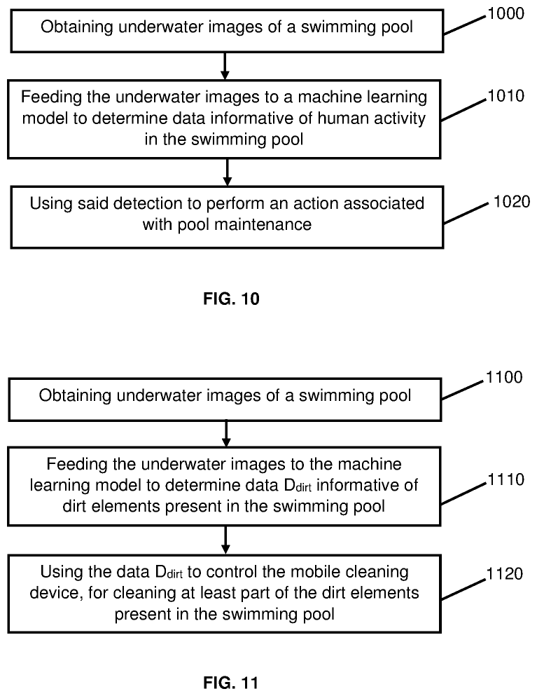

Attention is now drawn to FIG. 10.

The method includes obtaining (operation 1000) underwater images of a swimming pool acquired by at least one underwater camera 120.

The method further includes feeding (operation 1010) the underwater images (or data informative thereof, such as the underwater images after some image processing) to machine learning model (see reference 160 in FIG. 1A) to determine data informative of human activity in the swimming pool. Data informative of the human activity can include e.g., the number of humans (bathers) in the underwater images, estimated age of the humans, frequency of use of the pool, etc.

Image processing of the underwater images can include e.g., noise reduction, sharpening, filtering, etc. (this is not limitative).

According to some embodiments, the output of the machine learning model can used together with data provided by a computer vision algorithm used on the above-water images (e.g., blob detection algorithm, segmentation algorithm, shape detection algorithm, etc.) to determine data informative of human activity.

The training of the machine learning model can include supervised learning/semi-supervised learning, in which a training set of underwater images is fed to the machine learning model, together with a label provided e.g., by an operator. The underwater images include images in which humans are present in the pool. The label indicates the position the humans. The label can also indicate the age of the humans. The training set, together with the labels, are fed to the machine learning model for its training.

Note that the machine learning model can be trained to differentiate between human candidates and non-human candidates (e.g., cleaning robot, toys, debris), thereby avoiding false detection of objects as humans. The label can therefore indicate position of human candidates and position of non-human candidates.

According to some embodiments, the method can include (operation 1020) using the data informative of human activity in the swimming pool to perform an action associated with maintenance of the swimming pool.

According to some embodiments, the action includes sending a recommendation to a user to trigger cleaning of the pool, which depends at least on the data informative of human activity in the swimming pool. The recommendation can be sent on a device 155 of the user. For example, if human activity is high, this will probably generate more dirt elements and/or turbidity in the pool, and, therefore, the method can include a warning to the user that cleaning of the pool is recommended.

According to some embodiments, the action includes sending a command to the pool cleaning machinery 150 to clean the pool. For example, the method can include activating the mobile cleaning device of the pool and/or the cleaning pump(s) and/or the device enabling delivering chemical(s) within the pool and/or the main filtration system of the pool, in order to clean the pool.

In some embodiments, a command can be sent to variable-speed pool pump(s) to activate them.

Contrary to prior art systems, which operate according to a fixed predefined schedule, the method can control the pool cleaning machinery when human activity is high.

According to some embodiments, the method uses both data D_{dirt} informative of dirt elements present in the swimming pool, and data informative of human activity in the swimming pool, to perform an action relative to pool maintenance. For example, if there is an indication of an amount of dirt elements above a threshold, and there is also an indication of high human activity, an alert can be sent to a user and/or a command can be sent to the pool cleaning machinery to clean the pool. Note that various other rules can be defined, which indicate when (and which) action has to be performed, depending on data D_{dirt} informative of dirt elements present in the swimming pool and/or data informative of human activity in the swimming pool. These rules can be predefined, and/or can be improved over time, using continuous learning or other techniques.

Attention is now drawn to FIG. 11.

The method of FIG. 11 enables a control of (at least one) mobile cleaning robot 131 of the swimming pool.

The method includes obtaining (operation 1100) underwater images of a swimming pool acquired by at least one underwater camera 120. Operation 1100 is similar to operation 200 and is therefore not described again.

The method further includes feeding (operation 1110) the underwater images (or data informative thereof, such as the underwater images after some image processing) to a machine learning model (see e.g., reference 160 in FIG. 1) to determine data D_{dirt} informative of dirt elements present in the swimming pool. Operation 1110 is similar to operations 310, 320 described above, and is therefore not described again.

Image processing of the underwater images can include e.g., noise reduction, sharpening, filtering, etc. (this is not limitative).

According to some embodiments, the output of the machine learning model can be used together with data provided by a computer vision algorithm used on the underwater images (e.g., blob detection algorithm, segmentation algorithm, shape detection algorithm, etc.) to determine data D_{dirt}.

The method further includes using (operation 1120) the data D_{dirt} to control the mobile cleaning device, for cleaning at least some of the dirt elements present in the swimming pool.

According to some embodiments, operation 1120 includes determining a path for the mobile cleaning device based on the location of the dirt elements extracted from the data D_{dirt}. In some embodiments, the path can be optimized according to an optimization criterion. The optimization criterion can require a minimization of the length of the path and/or of the time required by the mobile cleaning device to cover the path. Note that calculation of the path can use algorithms such as, approximate solutions for the travelling salesperson problem (this is not limitative).

According to some embodiments, since the dirt elements are determined in the whole pool, a planned path can be initially determined for the mobile cleaning device, which enables covering all dirt elements present in the pool. As mentioned hereinafter, the path transmitted to the mobile cleaning device can be modified dynamically (depending on the removal of dirt elements by the mobile cleaning device, the actual path used by the mobile cleaning device, etc.).

Command(s) can be sent to the mobile cleaning device to ensure that the mobile cleaning device follows the calculated path. The command can be sent to a control unit of the mobile cleaning device, which is in charge of controlling the various actuators (wheels, motor, actuators controlling direction, etc.) of the mobile cleaning device.

According to some embodiments, the commands are determined by the processing circuitry 110 and can be communicated to the mobile cleaning device using different techniques.

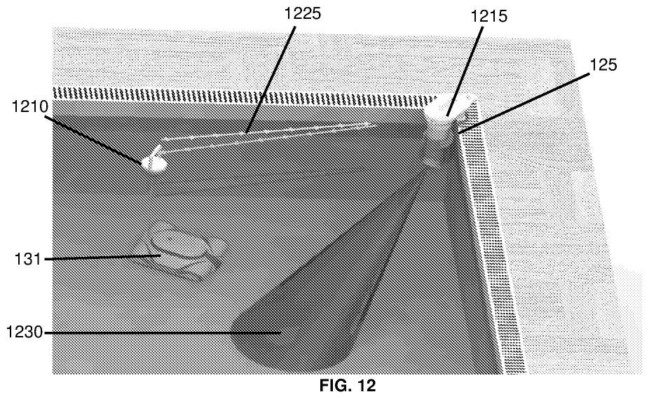

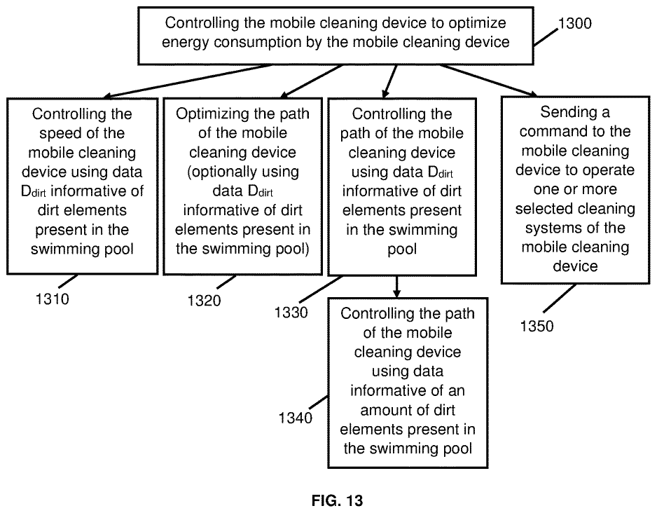

FIG. 12 illustrates a non-limitative example of communication between the processing circuitry 110 (which can be e.g., located within the pool unit 125) and the mobile cleaning device 131.

In this example, the mobile cleaning device 131 is connected (e.g., using a cable 1200) to a floating element 1210 (which floats on the surface of the swimming pool). The floating element can typically embed an antenna (not represented). The pool unit 125 also embeds an antenna (see 151 in FIG. 1A—located in the non-immersed part 1215 of the pool unit 125). Therefore, a remote communication 1225 (e.g., RF and/or Wi-Fi) between the two antennas can be performed, enabling communication (one way communication, or two-way communication) between the pool unit 125 embedding the processing circuitry 110 and the mobile cleaning device 131.

FIG. 12 also illustrates a dirt element 1230 captured by the camera of the pool unit 125, which can be detected in the images of the camera, as explained above.

According to some embodiments, communication between the processing circuitry 110 and the mobile cleaning device 131 can be underwater communication. In some embodiments, a predefined set of commands can be communicated between the processing circuitry 110 and the mobile cleaning device 131, such as direction commands (left, right, etc.) and action commands (brush, etc.). This enables reducing the amount of data to be transmitted, and therefore facilitates underwater communication. A non-limitative example of underwater communication is described in the following link: https://www.geektime.co.il/you-can-now-send-messages-underwater-with-this-app/, whose content is incorporated herein by reference.

According to some embodiments, detection of the data D_{dirt} informative of dirt elements (operation 1110) can rely on the various methods described above. In particular, in some embodiments, this can include using the method of FIG. 3D, which enables mapping the geometry of the pool, or other methods/variants described above.

According to some embodiments, control of the mobile cleaning device 131 (see operation 1120) can be performed to ensure cleaning of the pool which optimizes (e.g., minimizes) energy consumption by the mobile cleaning device 131. This can include various operations, as exemplified hereinafter. Such optimization can follow an optimization criterion, which can dictate various constraints on the path (e.g., minimization of its length), on the energy used for cleaning (e.g., selection of the most appropriate cleaning device of the mobile cleaning device, to reduce energy), and on the speed of the mobile cleaning device, in order to minimize energy consumption.

Note that optimization of the energy consumption by the mobile cleaning device 131 can be used to enable cleaning of the pool ((that is to say cleaning of all or most of the pool, at least once) by the mobile cleaning device 131 using energy provided only by a battery of the mobile cleaning device 131 (without requiring direct connection of the mobile cleaning device 131 to the external electricity power supply, and without requiring recharging the battery during the cleaning). The mobile cleaning device 131 can therefore be electrically autonomous when performing an entire cleaning of the pool (at least once, or more). Note that this can be performed while still enabling removing all or most of the dirt elements. This can be performed also without requiring changing the battery of regular mobile cleaning devices with a more powerful one (thereby avoiding increase of the weight and price of the mobile cleaning devices).

According to some embodiments, speed of the mobile cleaning device 131 is controlled using the data D_{dirt} (see operation 1310). For example, the mobile cleaning device 131 can be controlled to have a high speed at locations of the swimming pool in which dirt elements are absent, and to have a reduced speed at locations of the swimming pool in which dirt elements are present.

According to some embodiments, and as mentioned above, the path of the mobile cleaning device 131 is determined to meet an optimization criterion (see operation 1320 e.g., the path is selected to have a minimal length while enabling cleaning of the pool). For example, the optimization criterion can dictate that the path of the mobile cleaning device 131 covers all (or most of) of the floor and of the pool walls only once.

According to some embodiments, the path of the mobile cleaning device 131 is determined using data D_{dirt} (operation 1330). For example, in some embodiments, data D_{dirt} is informative of the amount of dirt elements at each location. This can be used to control the path of the mobile cleaning device 131 (see operation 1340). In particular, for each location(s) at which the amount of dirt elements is above a threshold (large amount of dirt elements), the mobile cleaning device 131 can be controlled to go over these locations at least twice (or more). For each location(s) at which the amount of dirt elements is below a threshold, the mobile cleaning device 131 can be controlled to go over these locations only once. This is not limitative.

According to some embodiments, the mobile cleaning device 131 is associated with one or more different cleaning systems (actuators). Examples of cleaning systems include (this is not limitative) vacuum systems, liquid jets, brushes (such as active scrubbing brushes), etc.

The method can include sending a command to the mobile cleaning device to operate one or more of the cleaning systems (operation 1350). In particular, the command can select only a fraction (and not all) of the cleaning systems to operate.

According to some embodiments, selection of the cleaning system(s) to operate is performed using the data D_{dirt}. In particular, according to some embodiments, selection of the cleaning system(s) to operate at each given location depends on the amount of the dirt elements at this given location. According to some embodiments, selection of the cleaning system(s) to operate at each given location depends on the type of the dirt element(s) at this given location. Indeed, some types of dirt elements can be more efficiently removed using liquid jets than using brushes, whereas other types of dirt elements can be more efficiently removed using brushes than with liquid jets. This example is not limitative.

This also enables optimizing energy consumption of the mobile cleaning device, by selecting the most optimal set of cleaning system(s) of the mobile cleaning device 131 used to remove the dirt elements located at each location.

In prior art systems, the pool's owner (user) manually triggers cleaning of the pool by the mobile cleaning device. This is problematic, since the user may forget to do so (for example when the user is absent from home), and this will cause an accumulation of dirt elements in the pool.

The method can include automatic triggering of the cleaning of the pool by the mobile cleaning device, using at least one of: the data D_{dirt} informative of dirt elements present in the swimming pool and/or data D_{turbidity} informative of water turbidity and/or data informative of human activity in the swimming pool. These data can be used (alone or in combination) to determine when cleaning of the pool is required by the mobile cleaning device.

The method can control automatically not only triggering of the cleaning by the mobile cleaning device, but also where to clean, and how long to operate the mobile cleaning device.

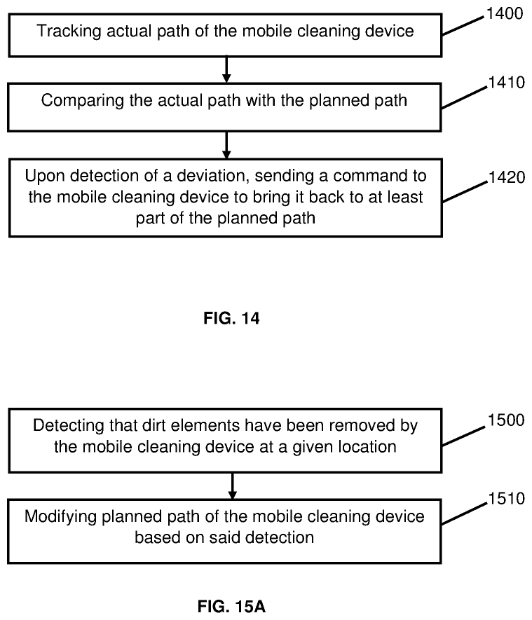

Attention is now drawn to FIG. 14.

According to some embodiments, control of the mobile cleaning device can be a dynamic control.

According to some embodiments, the method of FIG. 14 includes (operation 1400) determining data informative of the actual path of the mobile cleaning device in the pool (tracking of the mobile cleaning device). Note that the method of FIG. 9A can be used.

Indeed, it can occur that the actual path of the mobile cleaning device deviates from the planned path determined for the mobile cleaning device using the data D_{dirt}. This can be caused by various factors, such as presence of obstacles (toys, humans, etc.), momentary failure of the mobile cleaning device, etc.

The actual path can be compared to the planned path (operation 1410), and a command can be sent (operation 1420) to the mobile cleaning device to revert it back to (at least part of) the planned path (in particular when the mobile cleaning devices missed locations at which dirt elements were present due to this deviation).

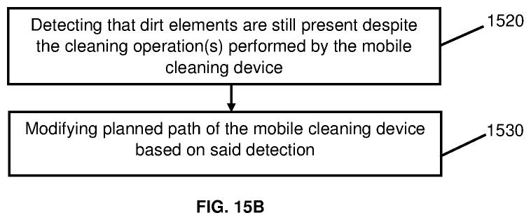

Another example of dynamic control of the mobile cleaning device is illustrated in FIG. 15.

Assume that, at a given location, it is detected that dirt elements initially present have been removed by the mobile learning device (operation 1500). Note that this detection can use a trained machine learning model, which can be trained to detect the absence of dirt elements in underwater images (using e.g., supervised/semi-supervised learning). This is however not limitative, and other image detection algorithms can be used.

Assume that the planned path initially required the mobile cleaning device to go over this given location twice (since the amount of dirt elements was high).

Since it has been detected that the dirt elements have been already removed, it is no longer necessary for the mobile cleaning device to go over this given location twice.

The method can therefore include sending a command to the mobile cleaning device to modify the planned path (operation 1510). In the example above, the command can cancel the repetition of the path on this given location (although the planned path originally required this repetition).

FIG. 15B illustrates a variant of the method of FIG. 15A.

Assume that, at a given location, it is detected that dirt elements are still present at a given location after a cleaning operation by the mobile learning device at this given location (operation 1520). Note that this detection can use the trained machine learning model used in the method of FIG. 3A.

Assume that the planned path initially required the mobile cleaning device to go over this given location only once.

Since it has been detected that the dirt elements are still present, it is necessary for the mobile cleaning device to go over this given location once again.

The method can therefore include sending a command to the mobile cleaning device to modify the planned path (operation 1510). In the example above, the command can require repetition of the path on this given location (although the planned path did not originally require this repetition).

According to some embodiments, a coverage map and/or a heat map of the mobile cleaning device can be determined using the methods described above with respect to FIGS. 9A to 9D. Their data can be used to monitor operation of the mobile cleaning device in real time quasi real time, and/or to provide feedback to the user, and/or to enable dynamic control of the path of the mobile cleaning device.

Embodiments of the presently disclosed subject matter are not described with reference to any particular programming language. It will be appreciated that a variety of programming languages may be used to implement the teachings of the presently disclosed subject matter as described herein.

The invention contemplates a computer program being readable by a computer for executing one or more methods of the invention. The invention further contemplates a machine-readable memory tangibly embodying a program of instructions executable by the machine for executing one or more methods of the invention.

It is to be noted that the various features described in the various embodiments may be combined according to all possible technical combinations.

The memories referred to herein can comprise one or more of the following:
internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

The terms “non-transitory memory” and “non-transitory computer readable medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

In embodiments of the presently disclosed subject matter, fewer, more, and/or different stages than those shown in the various methods described above may be executed. In embodiments of the presently disclosed subject matter, one or more stages illustrated in the methods described above may be executed in a different order, and/or one or more groups of stages may be executed simultaneously.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1-147. (canceled)

148. A system comprising at least one processing circuitry, wherein the at least one processing circuitry is operative to implement at least one machine learning model, wherein the at least one processing circuitry is configured to:
obtain underwater images of a swimming pool acquired by at least one underwater camera, and
feed the underwater images, or data informative thereof, to the at least one machine learning model to determine at least one of:
data D_{water_condition} informative of water condition in the swimming pool, or
data D_{activity} informative of an activity within the swimming pool,
wherein at least one of the data D_{water_condition} or D_{activity} is usable to perform an action associated with maintenance of the swimming pool.

149. The system of claim 148, wherein at least one of (i) of (ii) is met:
(i) the system is configured to use at least one of the data D_{water_condition} or D_{activity} to perform an action associated with maintenance of the swimming pool;
(ii) the system is configured to use at least one of the data D_{water_condition} or D_{activity} to perform an action associated with maintenance of the swimming pool, wherein the action comprises triggering displaying of at least one of data D_{water_condition} or D_{activity}on a display device to a user, thereby facilitating maintenance of the swimming pool for the user.

150. The system of claim 148, wherein at least one of (i) of (ii) is met:
(i) the system is configured to use at least one of the data D_{water_condition} or D_{activity} to perform an action associated with maintenance of the swimming pool, wherein the swimming pool is associated with a pool cleaning machinery for cleaning the swimming pool, wherein the action includes controlling the pool cleaning machinery based on at least one of data D_{water_condition} or D_{activity};
(ii) the system is configured to use at least one of the data D_{water_condition} or D_{activity} to perform an action associated with maintenance of the swimming pool, wherein the swimming pool is associated with a pool cleaning machinery for cleaning the swimming pool, wherein controlling the pool cleaning machinery includes controlling at least one of a filter of the swimming pool, or a pump of the swimming pool, or a device enabling delivering chemicals in the swimming pool.

151. The system of claim 148, wherein at least one of (i) or (ii) is met:
(i) the data D_{water_condition} includes data D_{dirt} informative of underwater dirt elements present in the swimming pool;
(ii) the data D_{water_condition} includes data D_{dirt} informative of underwater dirt elements present in the swimming pool, wherein the data D_{dirt} informative of dirt elements present in the swimming pool includes at least one of location of the dirt elements, amount of the dirt elements per location, respective segments of the swimming pool in which the dirt elements are located, wherein the respective segments are selected among a plurality of predefined segments mapping a geometry of the swimming pool, type of the dirt elements.

152. The system of claim 148, configured to:
obtain at least one image of the swimming pool acquired by at least one camera,
perform at least one of (i), (ii), (iii), (iv) or (v):
(i) feed the at least one image, or data informative thereof, to a machine learning model to determine data informative of floating dirt elements present in the swimming pool;
(ii) feed the at least one image, or data informative thereof, to a machine learning model to determine data informative of dirt elements obstructing a skimmer, and perform an action when an amount of dirt elements obstructing the skimmer is above a threshold;
(iii) feed the at least one image, or data informative thereof, to a machine learning model to determine data informative of water level of the swimming pool;
(iv) feed the at least one image to the machine learning model to detect that the water level of the pool is below a threshold, and upon said detection, send a command to a device to fill the swimming pool with water, or send an alert to a user informative of a need to fill the swimming pool;
(v) feed the at least one image to the machine learning model above-water image to determine a location at which the water level crosses the skimmer, and use said location to determine whether the water level meets a required threshold.

153. The system of claim 148, wherein at least one of (i), (ii) or (iii) is met:
(i) the data D_{activity} includes data informative of human activity in the swimming pool, wherein the system is configured to use said data informative of human activity in the swimming pool to perform the action associated with maintenance of the pool;
(ii) the data D_{activity} includes data informative of human activity in the swimming pool, wherein the data D_{water_condition} includes data D_{turbidity} informative of water turbidity in the swimming pool, and wherein the system is configured to use said data informative of human activity in the swimming pool, said data D_{turbidity} and data informative of an activity of a mobile cleaning robot of the swimming pool, to perform the action associated with maintenance of the swimming pool;
(iii) the data D_{activity} includes data informative of human activity in the swimming pool, wherein the data D_{water_condition} includes data D_{turbidity} informative of water turbidity in the swimming pool, and wherein the system is configured to use said data informative of human activity in the swimming pool, said data D_{turbidity} and data informative of an activity of a mobile cleaning robot of the swimming pool, to perform the action associated with maintenance of the swimming pool, said action corresponding to at least one of triggering a pool cleaning machinery for cleaning the swimming pool or triggering a device enabling delivering chemicals in the swimming pool.

154. The system of claim 148, wherein the data D_{activity} includes data informative of human activity in the swimming pool, wherein the data D_{water_condition} includes data D_{turbidity} informative of water turbidity in the swimming pool, and wherein the system is configured to use said data informative of human activity in the swimming pool, said data D_{turbidity} and data informative of an activity of a mobile cleaning robot of the swimming pool to control or optimize energy consumption of a pool cleaning machinery operative to clean the swimming pool.

155. The system of claim 148, wherein the at least one processing circuitry is operative to implement a first machine learning model and a second machine learning model, wherein the system is configured to:
feed at least one underwater image of the pool, or data informative thereof, to the first machine learning model to map a geometry of the pool in the image into a plurality of segments,
determine, using the second machine learning model and the plurality of segments determined by the first machine learning model, a location of dirt elements expressed with reference to one or more of the plurality of segments.

156. The system of claim 148, configured to perform at least one of (i), (ii), (iii), (iv), (v) or (vi):
(i) use data D_{dirt} informative of dirt elements present in the swimming pool determined based on underwater images of the swimming pool to control at least one of a path or a speed of a mobile cleaning device operative to clean the swimming pool;
(ii) control a path of the mobile cleaning device using data informative of an amount of dirt elements present in the swimming pool;
(iii) control a path of the mobile cleaning device to optimize energy consumption by the mobile cleaning device according to an optimization criterion;
(iii) control a path of the mobile cleaning device to optimize energy consumption of a pool cleaning machinery of the swimming pool;
(iv) determine an actual path of a mobile cleaning device in underwater images of the swimming pool, compare the actual path with a planned path of the mobile cleaning device, and, based on said comparison, send a command to the mobile cleaning device;
(v) control a mobile cleaning device of the swimming pool to enable cleaning of most or all of the swimming pool at least once, using energy provided only by a battery of the mobile cleaning device, and without requiring recharging said battery during said cleaning;
(vi) send a command to the mobile cleaning device of the swimming pool to operate a given selected cleaning system from different cleaning systems of the mobile cleaning device, wherein selection of the given selected cleaning system depends on data D_{dirt} informative of dirt elements present in the swimming pool.

157. The system of claim 148, configured to feed the underwater images, or data informative thereof, to the at least one machine learning model, or to another machine learning model, to map a geometry of the swimming pool present in the underwater image into a plurality of segments.

158. The system of claim 148, configured to feed the underwater images, or data informative thereof, to the at least one machine learning model, or to another machine learning model, to determine at least one of (i), (ii), (iii), (iv) or (v):
(i) data D_{turbidity} informative of water turbidity in the swimming pool,
(ii) data informative of one or more reasons for water turbidity in the swimming pool.
(iii) turbidity level in the swimming pool,
(iv) data D_{turbidity} informative of water turbidity in the swimming pool, wherein D_{turbidity} comprises one or more values of turbidity expressed in Formazin Nephelometric Units (FNU) or in Nephelometric Turbidity Units (NTU).
(v) turbidity level in the swimming pool, or values of turbidity in the swimming pool expressed in Formazin Nephelometric Units (FNU) or in Nephelometric Turbidity Units (NTU), wherein at least one of the turbidity level or the values of turbidity expressed in FNU or NTU are reported to a user.

159. The system of claim 158, wherein the pool is associated with a pool cleaning machinery operative to perform cleaning operations of the pool, wherein the system is configured to detect that water turbidity exceeds a threshold, and to control the pool cleaning machinery to reduce water turbidity.

160. The system of claim 148, wherein the pool is associated with a pool cleaning machinery including a plurality of cleaning devices, wherein the system is configured to send a command to a given cleaning device selected among the plurality of cleaning devices, for cleaning the pool, wherein the given cleaning device is selected based on data informative of one or more reasons for water turbidity in the swimming pool determined based on underwater images of the swimming pool.

161. The system of claim 148, configured to use a machine learning model to detect, in underwater images of the swimming pool, a mobile cleaning device operative to clean the swimming pool, and use said detection to monitor a path of the mobile cleaning device in the swimming pool.

162. The system of claim 161, wherein at least one of (i), (ii) or (iii) is met:
(i) monitoring the path of the mobile cleaning device in the swimming pool comprises determining a map informative of a coverage of the swimming pool by the mobile cleaning device;
(ii) monitoring the path of the mobile cleaning device in the swimming pool comprises determining a position of the mobile cleaning device in the pool is informative, and determining, for each position, a time spent by the mobile cleaning device at said position;
(iii) monitoring the path of the mobile cleaning device in the swimming pool comprises determining a heat map informative, for each position of the mobile cleaning device, of a time spent by the mobile cleaning device at said position.

163. The system of claim 148, configured to output at least one of:
a total duration during which the mobile cleaning robot has operated during a given cleaning operation of the swimming pool;
statistics on duration required by the mobile cleaning robot for cleaning the swimming pool;
an underwater image before pool cleaning and an underwater image after pool cleaning by the mobile cleaning device;
a pointer on dirt elements before cleaning by the mobile cleaning device, and a pointer on dirt elements left after cleaning by the mobile cleaning device;
data informative of the parts of the pool which have not been cleaned by the mobile cleaning device.

164. The system of claim 148, configured to perform at least one of (i) or (ii):
(i) control a mobile cleaning device of the swimming pool to enable cleaning of most or all of the swimming pool at least once, using energy provided only by a battery of the mobile cleaning device, and without requiring recharging said battery during said cleaning;
(ii) send a command to the mobile cleaning device of the swimming pool to operate a given selected cleaning system from different cleaning systems of the mobile cleaning device, wherein selection of the given selected cleaning system depends on data D_{dirt} informative of dirt elements present in the swimming pool.

165. The system of claim 148, configured to perform at least one of (i) or (ii):
(i) detect, using at least one underwater image, that dirt elements have been removed by a mobile cleaning device at a given location, and use said detection to modify a planned path of the mobile cleaning device;
(ii) detect, using at least one underwater image, that dirt elements are still present at a given location after a cleaning operation by the mobile cleaning device at this given location, and use said detection to modify a planned path of the mobile cleaning device.

166. A non-transitory computer readable medium comprising instructions that, when executed by at least one processing circuitry, cause the at least one processing circuitry to perform:
obtaining underwater images of a swimming pool acquired by at least one underwater camera, and
feeding the underwater images, or data informative thereof, to at least one machine learning model to determine at least one of:
data D_{water_condition} informative of water condition in the swimming pool, or
data D_{activity} informative of an activity within the swimming pool,
wherein at least one of the data D_{water_condition} or D_{activity} is usable to perform an action associated with maintenance of the swimming pool.

167. A non-transitory computer readable medium comprising instructions that, when executed by at least one processing circuitry, cause the at least one processing circuitry to perform:
obtaining underwater images of a swimming pool acquired by at least one underwater camera,
using a machine learning model to detect, in the underwater images, a mobile cleaning device operative to clean the swimming pool, and
using said detection to determine data informative of a path of the mobile cleaning device in the swimming pool.
